(19) United States
(12) Patent Application Publication
(10) Pub. No.: US 2026/0037880 A1
(43) Pub. Date: Feb. 5, 2026

(54) PREDICTION DEVICE, PREDICTION METHOD, AND NON-TRANSITORY COMPUTER READABLE MEDIUM

(71) Applicant: NEC Corporation, Tokyo (JP)

(72) Inventors: Keita SAKUMA, Tokyo (JP); Ryuta MATSUNO, Tokyo (JP); Masakazu HIROKAWA, Tokyo (JP)

(73) Assignee: NEC Corporation, Tokyo (JP)

(21) Appl. No.: 19/271,949

(22) Filed: Jul. 17, 2025

(30) Foreign Application Priority Data
Aug. 1, 2024 (JP) 2024-126081

(51) Int. Cl. G06N 20/20

(52) U.S. Cl. CPC G06N 20/20

(57) ABSTRACT

A prediction device includes at least one memory storing instructions, and at least one processor configured to execute the instructions to manage a model pool including a first model and one or more second models that generate one or more post-modulation outputs with reference to an output of the first model, and execute prediction processing using a plurality of models included in the model pool for decision making.

### INCORPORATION BY REFERENCE

This application is based upon and claims the benefit of priority from Japanese patent application No. 2024-126081, filed on Aug. 1, 2024, the disclosure of which is incorporated herein in its entirety by reference.

### TECHNICAL FIELD

The present disclosure relates to a prediction device, a prediction method, and a prediction program.

### BACKGROUND ART

A technique related to ensemble prediction using a model obtained by combining a plurality of models is known. For example, JP 2022-527366 A describes a method of generating a plurality of ensemble models using a supervised machine learning operation. The method generates a plurality of ensemble models from one or more data sets generated by combining one or more clusters of data points of a minority class with selected data points of a majority class.

### SUMMARY

In the method described in JP 2022-527366 A, since a plurality of ensemble models are generated using a supervised machine learning operation, there is a problem that the cost increases.

The present disclosure has been made in view of the above problems, and an example object thereof is to provide a technique for performing ensemble prediction at low cost.

A prediction device according to an example aspect of the present disclosure includes at least one memory storing instructions, and at least one processor configured to execute the instructions to manage a model pool including a first model and one or more second models that generate one or more post-modulation outputs with reference to an output of the first model, and execute prediction processing using a plurality of models included in the model pool.

A prediction method according to an example aspect of the present disclosure includes management processing in which at least one processor manages a model pool including a first model and one or more second models that generate one or more post-modulation outputs with reference to an output of the first model, and prediction processing in which the at least one processor executes prediction processing using a plurality of models included in the model pool.

A non-transitory computer readable medium storing a program that causes a computer to execute a management processing for managing a model pool including a first model and one or more second models that generate one or more post-modulation outputs with reference to an output of the first model, and a prediction processing for executing prediction processing using a plurality of models included in the model pool.

According to an example aspect of the present disclosure, there is an exemplary effect that a technique for performing ensemble prediction at low cost can be provided.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of a prediction device according to the present disclosure;

FIG. 2 is a flowchart illustrating a flow of a prediction method according to the present disclosure;

FIG. 3 is a block diagram illustrating a configuration of the prediction device according to the present disclosure;

FIG. 4 is a flowchart illustrating a flow of a prediction method according to the present disclosure;

FIG. 5 is a diagram illustrating a display example according to the present disclosure;

FIG. 6 is a diagram illustrating a display example according to the present disclosure;

FIG. 7 is a schematic diagram illustrating a specific example of a prediction device applied in the medical field according to the present disclosure;

FIG. 8 is a schematic diagram illustrating a specific example of a prediction device applied in the retail field according to the present disclosure;

FIG. 9 is a block diagram illustrating a configuration of a prediction device according to the present disclosure;

FIG. 10 is a flowchart for explaining an example of a detailed flow of weight update processing according to the present disclosure;

FIG. 11 is a flowchart illustrating an example of a detailed flow of prediction processing according to the present disclosure;

FIG. 12 is a diagram illustrating a display example according to the present disclosure;

FIG. 13 is a diagram illustrating a display example according to the present disclosure;

FIG. 14 is a block diagram illustrating a configuration of a prediction device according to the present disclosure;

FIG. 15 is a flowchart for explaining an example of a detailed flow of weight update processing according to the present disclosure;

FIG. 16 is a flowchart illustrating an example of a detailed flow of prediction processing according to the present disclosure;

FIG. 17 is a diagram illustrating a display example according to the present disclosure; and

FIG. 18 is a block diagram illustrating a configuration of a computer that functions as the prediction device according to the present disclosure.

### EXAMPLE EMBODIMENT

Hereinafter, example embodiments of the present disclosure will be described. However, the present disclosure is not limited to the example embodiments which will be described below, and various modifications can be made within the scope described in the claims. For example, example embodiments obtained by appropriately combining technical means adopted in the following example embodiments can also be included in the scope of the present disclosure. Example embodiments obtained by appropriately omitting some of the technical means adopted in the following example embodiments can also be included in the scope of the present disclosure. Effects mentioned in the following example embodiments are examples of effects expected in the example embodiments, and do not define the extension of the present disclosure. That is, example embodiments that do not achieve the effects mentioned in the following example embodiments can also be included in the scope of the present disclosure.

### First Example Embodiment

A first example embodiment that is an example embodiment of the present disclosure will be described in detail with reference to the drawings. The present example embodiment is a basic form of each example embodiment which will be described below. The application range of each technical means adopted in the present example embodiment is not limited to the present example embodiment. That is, each technical means adopted in the present example embodiment can also be adopted in other example embodiments included in the present disclosure as long as no particular technical problem occurs. Each technical means illustrated in the drawings referred to for describing the present example embodiment can also be adopted in other example embodiments included in the present disclosure as long as no particular technical problem occurs.

### (Configuration of Prediction Device)

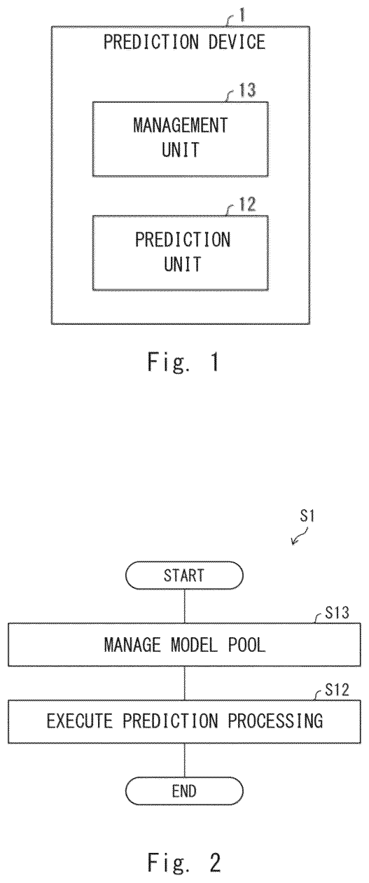

A configuration of a prediction device 1 will be described with reference to FIG. 1. FIG. 1 is a block diagram illustrating a configuration of the prediction device 1. As illustrated in FIG. 1, the prediction device 1 includes a management unit 13 and a prediction unit 12. The management unit 13 and the prediction unit 12 implement a management means and a prediction means, in the present example embodiment.

The management unit 13 manages a model pool including a first model and one or more second models that generate one or more post-modulation outputs with reference to the output of the first model.

The processing for managing the model pool by the management unit 13 includes, as an example, model generation processing for generating a second model for generating a post-modulation output with reference to the output of the first model, and model addition processing for adding the generated second model to the model pool. Here, in the model generation processing, a plurality of second models that generate a plurality of different post-modulation outputs may be generated for a certain output of the first model.

As an example, in a case where a function expressing the first model or an output of the function is expressed as f₁, the management unit 13 may generate, in the model generation processing, a second model f₂ that receives f₁ as an input and outputs f₁+10, and a plurality of second models different from each other such as a second model f₃ that receives f₁ as an input and outputs f₁−10.

The first model is a model that performs prediction, and is, for example, a machine learning model generated by machine learning. Examples of the machine learning model include, but are not limited to, a deep neural network (DNN), a gradient boosting decision tree (GBDT), a linear regression model, and the like.

The prediction unit 12 executes prediction processing using a plurality of models included in the model pool. As an example, the prediction unit 12 generates a prediction result with reference to the output of each of the plurality of models included in the model pool and the weight of each of the plurality of models.

### (Effects of Prediction Device)

As described above, the prediction device 1 employs a configuration including the management unit 13 that manages the model pool including the first model and one or more second models that generate one or more post-modulation outputs with reference to the output of the first model, and the prediction unit 12 that executes the prediction processing using the plurality of models included in the model pool.

Therefore, according to the prediction device 1, various second models are generated without being learned, and the prediction processing is executed using the model pool including the second model. Therefore, according to the prediction device 1, an effect that ensemble prediction can be performed at low cost can be obtained.

### (Implementation Example by Program)

In a case where the prediction device 1 is configured by a computer including at least one processor and a memory, the following prediction program is stored in the memory. The prediction program is a program that causes a computer to function as the prediction device 1, and causes the computer to function as: a management unit 13 that manages a model pool including a first model and one or more second models that generate one or more post-modulation outputs with reference to an output of the first model; and a prediction unit 12 that executes prediction processing using a plurality of models included in the model pool.

### (Flow of Prediction Method)

A flow of a prediction method S1 will be described with reference to FIG. 2. FIG. 2 is a flowchart illustrating the flow of the prediction method S1. As illustrated in FIG. 2, the prediction method S1 includes management processing S13 and prediction processing S12.

In the management processing S13, at least one processor manages a model pool including a first model and one or more second models that generate one or more post-modulation outputs with reference to the output of the first model.

In the prediction processing S12, at least one processor executes the prediction processing using the plurality of models included in the model pool.

### (Effect of Prediction Method S1)

As described above, in the prediction method S1, a configuration is adopted in which at least one processor includes: the management processing S13 of managing the model pool including the first model and one or more second models that generate one or more post-modulation outputs with reference to the output of the first model; and the prediction processing S12 of executing the prediction processing using the plurality of models included in the model pool. Therefore, according to the prediction method S1, the same effect as that of the prediction device 1 described above can be obtained.

### Second Example Embodiment

A second example embodiment that is an example of an example embodiment of the present disclosure will be described in detail with reference to the drawings. Components having the same functions as the components described in the above-described example embodiments are denoted by the same reference signs, and the description thereof will be appropriately omitted. The application range of each technical means adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### (Configuration of Prediction Device 1A)

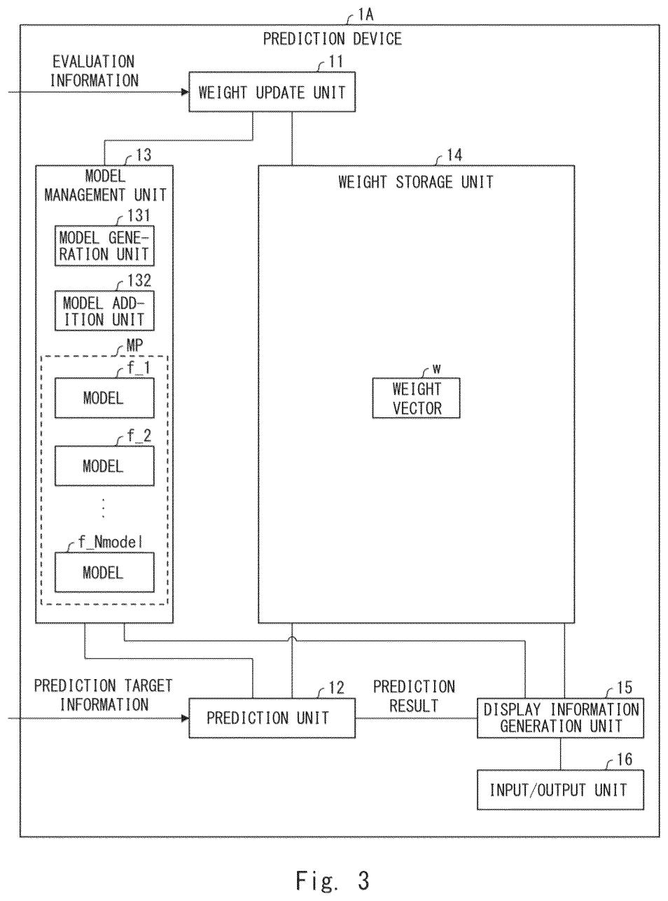

A configuration of a prediction device 1A will be described with reference to FIG. 3. FIG. 3 is a block diagram illustrating a configuration of the prediction device 1A. As illustrated in FIG. 3, the prediction device 1A includes a weight update unit 11, a prediction unit 12, a model management unit 13 (relevant to the management unit 13 in the above-described example embodiment), a weight storage unit 14, a display information generation unit 15, and an input/output unit 16. The weight update unit 11, the prediction unit 12, the model management unit 13, and the display information generation unit 15 implement an update means, a prediction means, a management means, and a display information generation means, in the present example embodiment.

### (Model Management Unit 13)

The model management unit 13 manages the model pool MP. As illustrated in FIG. 3, the model pool MP includes Nmodel models f_1, f_2, . . . , and f_Nmodel. Nmodel is a natural number of 2 or more. In other words, the model pool MP includes the model set F expressed by the following Expression (1).

$$\begin{matrix}[ Math . 1 ] & \\ {ℱ = ( {f}_{\_ i} \}}_{i = 1}^{{N}^{model}} & ( 1 )\end{matrix}$$

Hereinafter, the model f_1 is also referred to as a first model, and models other than the model f_1 (model f_2, . . . , model f_Nmodel) are also referred to as a second model. As illustrated in FIG. 3, the model management unit 13 includes a model generation unit 131 and a model addition unit 132.

### (Model Generation Unit 131)

The model generation unit 131 executes model generation processing of generating models f_2, . . . , and f_Nmodel that generate a post-modulation output with reference to the output of the model f_1. The model generation unit 131 can also be expressed as generating a plurality of post-modulation outputs with reference to the output of the model f_1.

An example of the model generated by the model generation unit 131 is a model that outputs a value obtained by adding an offset to the output value f₁ of the model f_1 in a case where the model f_1 is a regression model. An example of the model is shown below.
Output value f₂ of model f_2=f₁+10
Output value f₃ of model f_3=f₁−10
Output value f₄ of model f_4=f₁+20
Output value f₅ of model f_5=f₁−20

Another example of the model generated by the model generation unit 131 is a model that outputs a result obtained by switching any two or more certainty factors among the output results of the model f_1 that outputs the output value and the certainty factor (prediction probability) of the output value. An example of the model is shown below. The following is an example of the models f_2, f_3, and f_4 in a case where the model f_1 outputs the output value fₒ₁ of the prediction probability pp₁, the output value fₒ₂ of the prediction probability pp₂ lower than the prediction probability pp₁, and the output value fₒ₃ of the prediction probability pp₃ lower than the prediction probability pp₂. Hereinafter, the prediction probabilities are also referred to as “first prediction probability”, “second prediction probability”, . . . in descending order.
Model f_2: outputs an output value fₒ₁ of the prediction probability pp₂, an output value fₒ₂ of the prediction probability pp₁, and an output value fₒ₃ of the prediction probability pp₃
Model f_3: outputs an output value fₒ₁ of the prediction probability pp₃, an output value fₒ₂ of the prediction probability pp₂, and an output value fₒ₃ of the prediction probability pp₁
Model f_4: outputs an output value fₒ₁ of the prediction probability pp₁, an output value fₒ₂ of the prediction probability pp₃, and an output value fₒ₃ of the prediction probability pp₂.

For example, in a case where the model f_1 is a classification model and the classification probability pp₁ into the class 1 and the classification probability pp₂ into the class 2, the model generation unit 131 generates the model f_2 or the like that outputs the classification probability pp₂ into the class 1 and the classification probability pp₁ into the class 2.

The post-modulation output that is output by the second model is not limited to the above-described example, and may be a post-modulation output that can be interpreted as to what value the post-modulation output is. For example, the second model may be a model that generates the post-modulation output using a polynomial function using the output of the first model as an argument. For example, the second model may be a model that generates a post-modulation output obtained by raising the output of the first model to the power of 2, or a model that generates a post-modulation output obtained by raising the output of the first model to the power of 3.

### (Model Addition Unit 132)

The model addition unit 132 executes model addition processing of adding the second model generated by the model generation unit 131 to the model pool MP.

### (Weight Storage Unit 14)

The weight vector w is stored in the weight storage unit 14. The weight vector w is expressed by the following Expression (2).

$$\begin{matrix}[ Math . 2 ] & \\ w = ( {w}_{1} , {w}_{2} , … , {w}_{Nmodel} ) & ( 2 )\end{matrix}$$

The weight wᵢ is a weight given to the model f_i. The weight vector w is updated by the weight update unit 11, and the initial value of each element is arbitrarily determined. For example, the initial values of the elements may all be equal, or may be randomly determined.

(Prediction unit 12)

The prediction unit 12 executes prediction processing by inputting prediction target information regarding the prediction target to the model f_1. The prediction target information is also referred to as an explanatory variable. The prediction unit 12 supplies the prediction result to the display information generation unit 15.

The prediction target is a target to be predicted using each model f_i, and includes, but is not limited to, a sales amount, a hospital bed usage rate, a classification of human behavior, and the like, for example. The prediction target is also referred to as, for example, a target variable. The prediction target information is information input to the model f_1, and is also referred to as an explanatory variable. In a case where the prediction target is the sales amount of the target date, the prediction target information may include, for example, the weather of the target date. In a case where the prediction target is the hospital bed usage rate after one week, the prediction target information may include the latest bed usage rate. In the case that the prediction target is the classification of the human behavior, the prediction target information may include the image in which the person is photographed.

The prediction unit 12 generates a prediction result with reference to the output of each of the plurality of models f_i included in the model pool MP and the weight wᵢ of each of the plurality of models f_i. In the case of the regression task, assuming that the output in a case where the prediction target information is input to the model f_i is fᵢ, the prediction result is expressed by the following Expression (3).

$$\begin{matrix}[ Math . 3 ] & \\ {\sum }_{i = 1}^{Nmodel} {w}_{i} {f}_{i} & ( 3 )\end{matrix}$$

In other words, the prediction result is calculated as a weighted linear sum using the weight wᵢ for the output f₁ of each model. The prediction result is also referred to as a prediction value of the ensemble prediction. The weight wᵢ in Expression (3) is a normalized value. In the case of the weight wᵢ that is not normalized, Expression (3) may be divided by the sum of the weights wᵢ.

In the case of the classification task, as an example, f₁ represents a vector of a class number dimension, and the prediction probability for each class label i is expressed by f₁. Then, the prediction unit 12 can calculate the post-integration prediction probability using the same expression as the above Expression (3). In a case where a label is finally determined as a prediction value, the prediction unit 12 determines a class label having the highest probability as the label as the prediction value.

For example, a case where the prediction target is a sales amount on a target date, and the prediction target information includes a store periphery image captured around a store on the target date and a weekday/holiday label indicating a weekday or holiday will be described. In this case, the prediction unit 12 inputs the prediction target information to the model f_1 to acquire the output value f₁ of the model f_1, the output values f₂ of the model f_2 that has referred to the output value f₁, . . . and the output value f_Nmodel of the model f_Nmodel that has referred to the output value f₁.

Then, the prediction unit 12 calculates the sales amount that is the prediction result using the above-described Expression (3).

### (Weight Update Unit 11)

The weight update unit 11 updates the weight. As an example, the weight update unit 11 updates the weight wᵢ which is each element of the weight vector W.

As an example, the weight update unit 11 updates the weight wᵢ with reference to the evaluation information. The evaluation information is information obtained over time after the start of operation, and is different from the prediction target information. As the evaluation information, prediction target information referred to by the prediction unit 12 in past prediction processing may be applied, but the present disclosure is not limited thereto. The evaluation information may include a true value relevant to the prediction result. In this case, the weight update unit 11 updates the weight wᵢ by comparing the prediction result predicted by each model with reference to the prediction target information with the true value included in the evaluation information.

For example, the weight update unit 11 may update some or all of the weight wᵢ based on a plurality of pieces of evaluation information and the evaluation result of the performance of each model f_i with reference to the plurality of pieces of evaluation information. The performance evaluation result of each model f_i with reference to the plurality of pieces of evaluation information may be, for example, a statistical value (for example, an average value, a maximum value, a minimum value, and the like) of the performance evaluation result of each model f_i with reference to each piece of evaluation information.

### (Display Information Generation Unit 15)

The display information generation unit 15 generates display information. As an example, the display information generation unit 15 generates display information including at least one of the weight wᵢ of each of the plurality of models included in the model pool MP and information obtained from the weight wᵢ. The display information generation unit 15 supplies the generated display information to the input/output unit 16. An example of the display information generated by the display information generation unit 15 will be described later.

### (Input/Output Unit 16)

The input/output unit 16 includes at least one of input/output devices such as a keyboard, a mouse, a display, a printer, and a touch panel. Alternatively, input/output devices such as a keyboard, a mouse, a display, a printer, and a touch panel may be connected to the input/output unit 16. With such a configuration, the input/output unit 16 receives inputs of various types of information to the prediction device 1A from the connected input device. The input/output unit 16 outputs various types of information to the connected output device. The input/output unit 16 may adopt, for example, an interface such as a universal serial bus (USB). As an example, the input/output unit 16 displays the display information generated by the display information generation unit 15. In other words, the input/output unit 16 also has a configuration as a display unit that displays display information.

### (Flow of Prediction Method S1A)

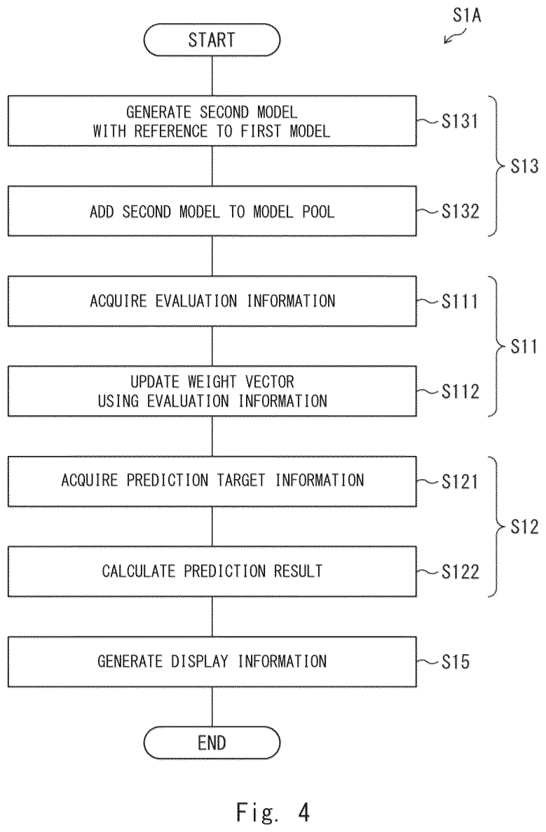

A flow of the prediction method SIA executed by the prediction device 1A will be described with reference to FIG. 4. FIG. 4 is a flowchart illustrating a flow of the prediction method SIA.

### (Management Processing S13)

In the management processing S13, the model management unit 13 manages the model pool MP including the model f_1 and the models f_2, . . . , f_Nmodel that generate one or more post-modulation outputs with reference to the output of the model f_1. More specifically, in the management processing S13, the model management unit 13 executes the following model generation processing S131 and model addition processing S132.

### (Model Generation Processing S131)

In the model generation processing S131, the model generation unit 131 executes model generation processing of generating models f_2, . . . , f_Nmodel, which are second models that generate a post-modulation output with reference to the output of the model f_1 which is the first model. The method for generating the models f_2, . . . , f_Nmodel for generating the post-modulation output by the model generation unit 131 is as described above.

### (Model Addition Processing S132)

In the model addition processing S132, the model addition unit 132 adds the models f_2, . . . , the model f_Nmodel, which are the second models, to the model pool MP.

### (Weight Update Processing S11)

In the weight update processing S11, the weight update unit 11 updates the weight wᵢ which is each element of the weight vector w. More specifically, in the weight update processing S11, the weight update unit 11 executes evaluation information acquisition processing S111 and update processing S112.

### (Evaluation Information Acquisition Processing S111)

In the evaluation information acquisition processing S111, the weight update unit 11 acquires the evaluation information.

### (Update Processing S112)

In the update processing S112, the weight update unit 11 updates the weight wᵢ, which is each element of the weight vector w, with reference to the evaluation information. The method by which the weight update unit 11 updates the weight wᵢ is as described above.

### (Prediction Processing S12)

In the prediction processing S12, the prediction unit 12 executes the prediction processing by inputting prediction target information regarding the prediction target to the model f_1. More specifically, in the prediction processing S12, the prediction unit 12 executes prediction target information acquisition processing S121 and calculation processing S122.

### (Prediction Target Information Acquisition Processing S121)

In prediction target information acquisition processing S121, the prediction unit 12 acquires prediction target information.

### (Calculation Processing S122)

In the calculation processing S122, the prediction unit 12 calculates the prediction result by inputting the prediction target information to the model f_1. As described above, the prediction unit 12 calculates the prediction result as the weighted linear sum using the weight wᵢ for the output f₁ of each model.

### (Display Information Generation Processing S15)

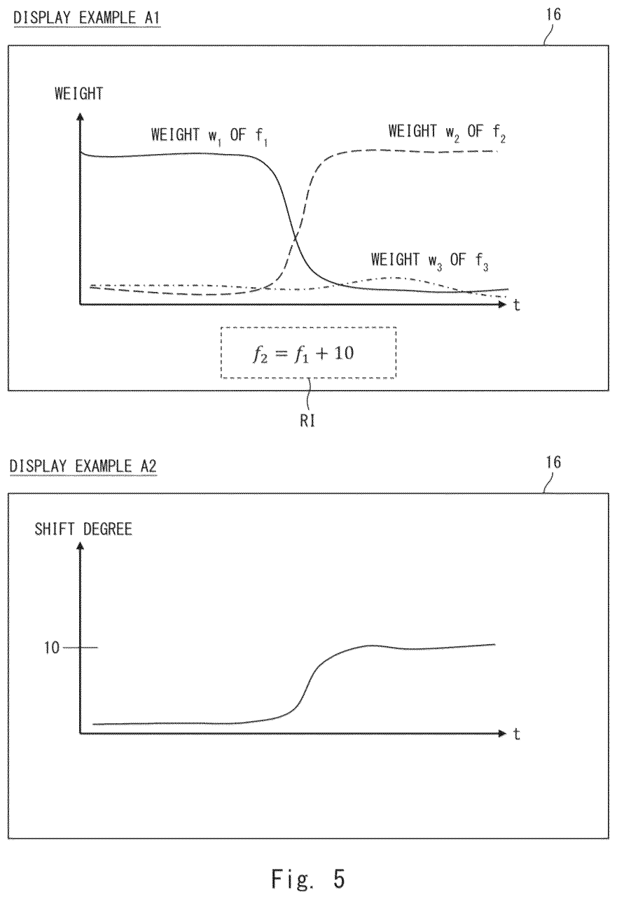

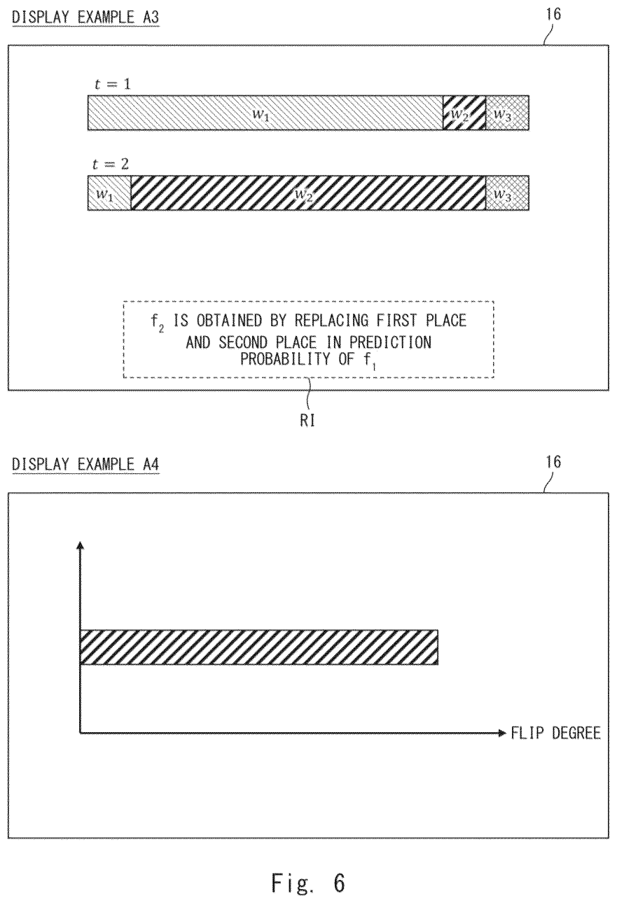

In the display information generation processing S15, the display information generation unit 15 generates display information. The display information generation unit 15 supplies the display information to the input/output unit 16. The input/output unit 16 displays the display information. An example of the display information displayed by the input/output unit 16 will be described with reference to FIGS. 5 and 6. FIG. 5 is a diagram illustrating a display example A1 and a display example A2. FIG. 6 is a diagram illustrating a display example A3 and a display example A4.

As described above, the display information generation unit 15 generates the display information including the weight wᵢ of each of the plurality of models included in the model pool MP. As an example, as illustrated in a display example A1 of FIG. 5, the display information generation unit 15 generates display information for displaying a graph in which a horizontal axis is time and a vertical axis is weight. The display example A1 shows that the weight wᵢ for the output f₁ of the model f_1, the weight w₂ for the output f₂ of the model f_2, and the weight w₃ for the output f₃ of the model f_3 change with the lapse of time. In other words, in the display example A1, the time series of weights is visualized. For example, in the display example A1, it is indicated that the value of the weight wᵢ decreases and the value of the weight w₂ increases after a lapse of a certain time, and the value of the weight w₃ does not change greatly regardless of the lapse of time.

With this configuration, the display information generation unit 15 can present to the user what kind of distribution shift occurs over time and which model is used among the models included in the model pool MP.

The display information may include modulation information indicating how to generate a post-modulation output by the second model among the plurality of models included in the model pool MP. For example, in the display example A1, the display information includes modulation information RI indicating how to generate the output f₂ after modulation by the model f_2 that is the second model (f₂=f₁+10). That is, the modulation information can also be referred to as relationship information indicating a relationship between the output of the first model and the output of the second model.

As described above, the post-modulation output is a post-modulation output that allows interpretation of a value of the post-modulation output. For example, the second model may be a model that generates the post-modulation output using a polynomial function using the output of the first model as an argument. Therefore, since the display information includes the modulation information, the display information generation unit 15 can present to the user what kind of model the model included in the model pool MP is, and the relationship between the first model f_1 and the second model.

As described above, the display information generation unit 15 generates display information including information obtained from the weight wᵢ. As an example, as illustrated in the display example A2 of FIG. 5, the display information generation unit 15 generates display information for displaying a graph in which a horizontal axis is time and a vertical axis is a shift degree obtained from the weight wᵢ. As an example, the display information generation unit 15 calculates the shift degree using the following Expression (6).

$$\begin{matrix}[ Math . 4 ] & \\ {\sum }_{i}^{Nmodel} {w}_{i} \times ( OFFSET OF {f}_{i} ) & ( 6 )\end{matrix}$$

That is, the display information generation unit 15 calculates a weighted average of the offset as the shift degree. The weight wᵢ in Expression (6) is a normalized value. In the case of the weight wᵢ that is not normalized, Expression (6) may be divided by the sum of the weights wᵢ.

With this configuration, the display information generation unit 15 can present to the user what kind of distribution shift has occurred over time.

The display information generation unit 15 may generate display information for displaying a bar plot. As an example, as illustrated in a display example A3 of FIG. 6, the display information generation unit 15 generates display information for displaying the value of the weight wᵢ at a certain time as a bar plot. In the display example A3, if t=1 to t=2, the weight wᵢ for the output f₁ of the model f_1 and the weight w₂ for the output f₂ of the model f_2 change, and the weight w₃ for the output f₃ does not change significantly.

Even in this configuration, the display information generation unit 15 can present to the user what kind of distribution shift occurs over time and which model is used among the models included in the model pool MP.

Similarly to the example described above, the display information may include modulation information RI indicating that the output f₂ after modulation by the model f_2 is obtained by replacing the first place and the second place in the prediction probability of the output f₁ of the model f_1, as illustrated in the display example A3.

Also in this configuration, the display information generation unit 15 can present to the user what kind of model the model included in the model pool MP is, and the relationship between the first model f_1 and the second model.

The display information generation unit 15 may generate display information for displaying a flip degree, which is information obtained from the weight wᵢ, as illustrated in the display example A4 of FIG. 6. As an example, the display information generation unit 15 calculates the flip degree using the following Expression (7).

$$\begin{matrix}[ Math . 5 ] & \\ {\sum }_{i \neq 1}^{Nmodel} {w}_{i} & ( 7 )\end{matrix}$$

That is, the display information generation unit 15 calculates the sum of the weights wᵢ of the second model as the flip degree. The display information generation unit 15 may generate display information that displays the time series of the flip degree. The weight wᵢ in Expression (7) is a normalized value. In the case of the weight wᵢ that is not normalized, Expression (7) may be divided by the sum of the weights wᵢ.

Also in this configuration, the display information generation unit 15 can present to the user how much the distribution shift has occurred from the time of learning of the first model f_1.

### (Effects of Prediction Device 1A)

According to the prediction device 1A configured as described above, similarly to the prediction device 1 according to the first example embodiment, various second models (model f_2, . . . , model f_Nmodel) are generated without being learned, and the prediction processing is executed using the model pool MP including the second model. Therefore, according to the prediction device 1A, an effect that ensemble prediction can be performed at low cost can be obtained.

### First Application Example

Hereinafter, application examples of the prediction devices 1 and 1A described above will be described. In the following description, an application example of the prediction device 1A will be described, but application examples of the prediction device 1 can be similarly achieved.

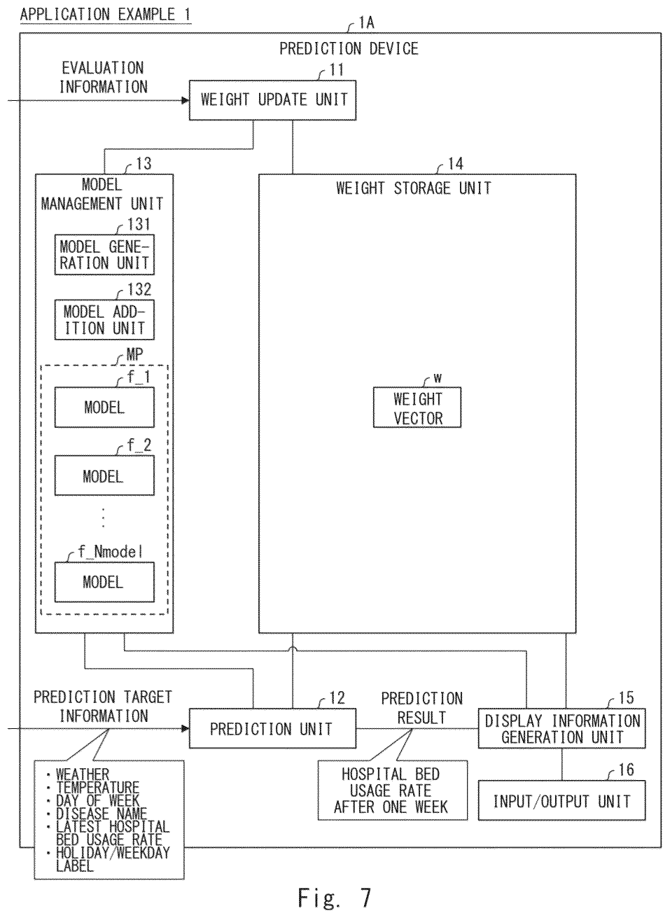

For example, the prediction device 1A is applicable in the medical field. A specific example of the prediction device 1A applied in the medical field will be described with reference to FIG. 7. FIG. 7 is a schematic diagram illustrating a specific example of a prediction device 1A applied in the medical field. In this example, the prediction target is set to “hospital bed usage rate after one week”, and the prediction target information is set to “weather, temperature, day of week, disease name, latest hospital bed usage rate, holiday/weekday label”. Here, the information regarding weather is acquired from a weather providing server via an application programming interface (API) by communication via a communication unit (not illustrated) included in the prediction device 1A. The information regarding the temperature is acquired from a temperature sensor connected to the prediction device 1A via the input/output unit 16.

The prediction device 1A stores models f_1, f_2, . . . , and f_Nmodel. The model f_1 is generated in advance by a learning algorithm using training data.

Then, the prediction device 1A executes the management processing S13, generates the models f_2, . . . , the model f_Nmodel that generate the post-modulation output with reference to the output of the model f_1, and adds the models to the model pool MP.

The prediction device 1A repeats update processing S11, prediction processing S12, and display information generation processing S15. Then, the “hospital bed usage rate after one week” which is the prediction result derived by the prediction device 1A is input to the reservation management system connected to the prediction device 1A, and is referred to for optimizing the number of beds to be secured. According to this configuration, even in a case where the distribution of the information related to the prediction target locally changes, the prediction device 1A can perform the ensemble prediction with high accuracy.

### Second Application Example

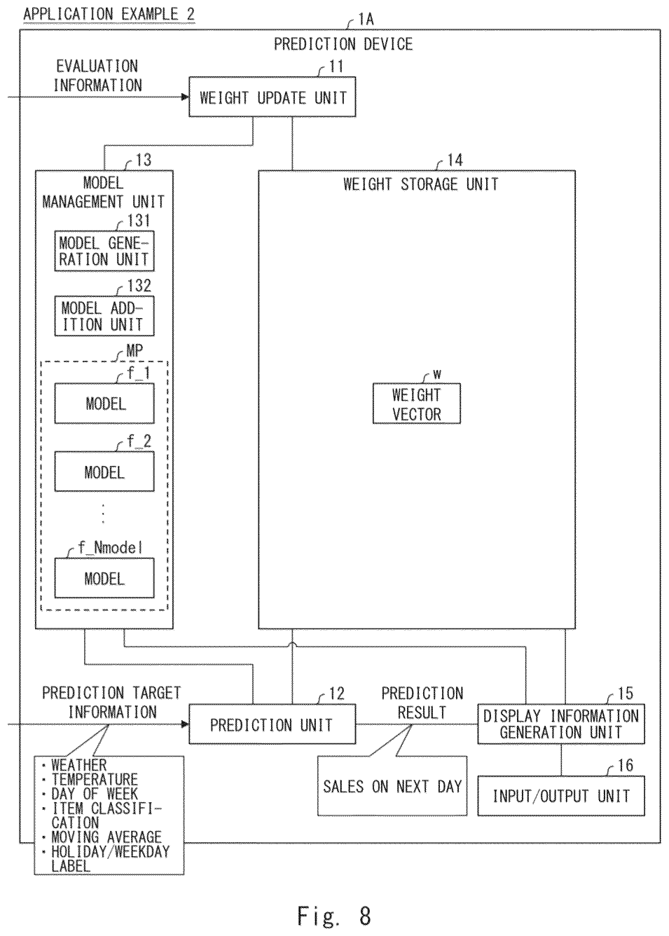

As another example, the prediction device 1A is applicable to demand prediction. A specific example of the prediction device 1A applied to demand prediction will be described with reference to FIG. 8. FIG. 8 is a schematic diagram illustrating a specific example of a prediction device 1A applied to demand prediction. In this example, the prediction target is “sales on the next day”, and the prediction target information is “weather, temperature, day of week, item classification, moving average, holiday/weekday label”. Here, the information regarding weather is acquired from a weather providing server via an application programming interface (API) by communication via a communication unit (not illustrated) included in the prediction device 1A. The information regarding the temperature is acquired from a temperature sensor connected to the prediction device 1A via the input/output unit 16.

The prediction device 1A stores models f_1, f_2, . . . , and f_Nmodel. The model f_1 is generated in advance by a learning algorithm using training data.

Then, the prediction device 1A executes the management processing S13, generates the models f_2, . . . , the model f_Nmodel that generate the post-modulation output with reference to the output of the model f_1, and adds the models to the model pool MP.

The prediction device 1A repeats update processing S11, prediction processing S12, and display information generation processing S15. Then, “sales on the next day” that is the prediction result derived by the prediction device 1A is input to a reservation management system connected to the prediction device 1A, and is referred to for optimizing the order quantity. According to this configuration, even in a case where the distribution of the information related to the prediction target locally changes, the ensemble prediction can be performed with high accuracy.

### Third Example Embodiment

A third example embodiment that is an example of an example embodiment of the present disclosure will be described in detail with reference to the drawings. Components having the same functions as the components described in the above-described example embodiments are denoted by the same reference signs, and the description thereof will be appropriately omitted. The application range of each technical means adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### (Outline of Prediction Device 1B)

In addition to the configurations of the prediction device 1 and the prediction device 1A, the prediction device 1B has a configuration to update some or all of the plurality of weight vectors w_i based on an evaluation result obtained by evaluating the performance of each model f_i with reference to evaluation information including model input information for evaluation obtained over time after the operation of the plurality of models f_i is started, and the evaluation information.

The prediction device 1B outputs a prediction result obtained by integrating the prediction results predicted by the models f_i with reference to the model input information included in the prediction target information related to the prediction target using the weight vector w_i selected based on the prediction target information among the plurality of weight vectors w_i.

Here, the number of weight vectors w_i selected based on the prediction target information is not limited to one, and may be plural. In a case where there are a plurality of selected weight vectors w_i, an integrated weight vector obtained by integrating the plurality of selected weight vectors w_i may be used to integrate the prediction results of the models.

### (Configuration of Prediction Device 1B)

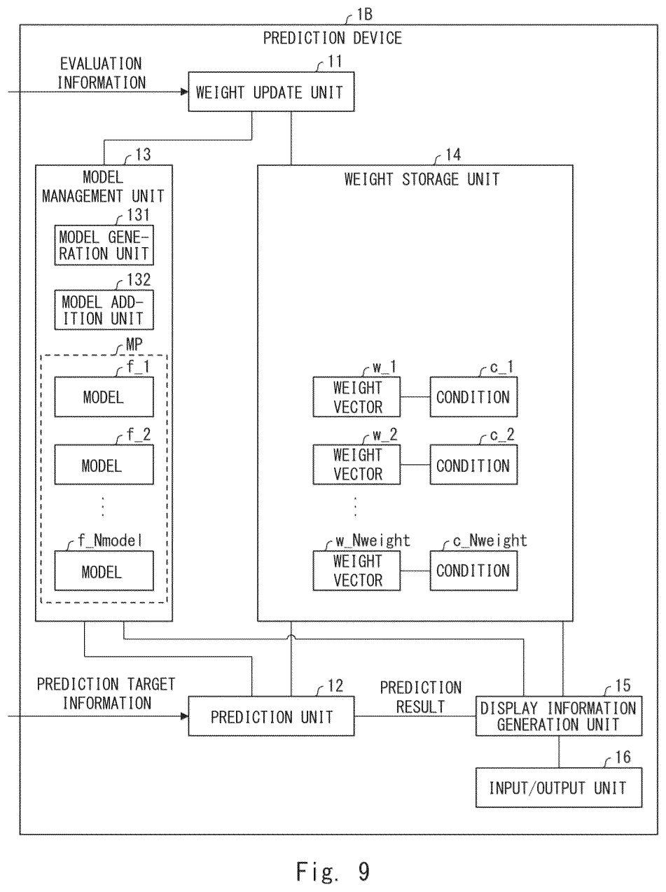

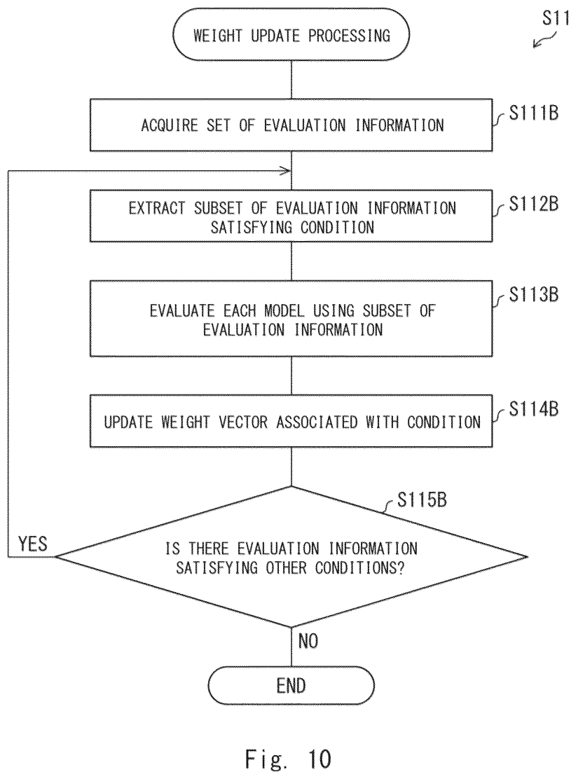

A configuration of the prediction device 1B will be described with reference to FIG. 9. FIG. 9 is a block diagram illustrating a configuration of the prediction device 1B. As illustrated in FIG. 9, the prediction device 1B includes a weight update unit 11, a prediction unit 12, a model management unit 13, a weight storage unit 14, a display information generation unit 15, and an input/output unit 16. The weight update unit 11, the prediction unit 12, the model management unit 13, and the display information generation unit 15 implement an update means, a prediction means, a management means, and a display information generation means, in the present example embodiment.

Since the model management unit 13 and the input/output unit 16 have the same configurations as those of the above-described example embodiment, the description thereof will be omitted.

### (Weight Storage Unit 14)

The weight storage unit 14 is configured as follows in addition to being configured similarly to the above-described example embodiment. The weight storage unit 14 stores Nweight weight vectors w_1, w_2, . . . , and w_Nweight. Nweight is a natural number of 2 or more. In other words, the weight storage unit 14 stores the weight set W expressed by the following Expression (8).

$$\begin{matrix}[ Math . 6 ] & \\ 𝒲 = {\{ {w}_{\_ j} \}}_{j = 1}^{{N}^{weight}} & ( 8 )\end{matrix}$$

The weight vector w_j is a vector having Nmodel weights w_j_i as elements, and is expressed by the following Expression (9).

$$\begin{matrix}[ Math . 7 ] & \\ {w}_{\_ j} = ( {w}_{\_ j \_ 1} , … , {w}_{\_ j {\_ N}^{model}} ) & ( 9 )\end{matrix}$$

The weight w_j_i represents a weight given to the model f_i in a case where the weight vector w_j is selected. The weight vector w_j may be updated by the weight update unit 11, and the initial value of each element is arbitrarily determined. For example, the initial values of the elements may all be equal, or may be randomly determined.

Here, each of the plurality of weight vectors w_j stored in the weight storage unit 14 is associated with at least one of a plurality of conditions that can be satisfied by the prediction target information and can be satisfied by the evaluation information. For example, each of the plurality of conditions c_j may be a condition that can be satisfied by the model input information. As an example, in a case where the model input information includes a weekday/holiday label, a condition c_1 “weekday” and a condition c_2 “holiday” may be set as the plurality of conditions c_1 and c_2. In a case where the evaluation information and the prediction target information include the additional information, each of the plurality of conditions c_j may be a condition that can be satisfied by the additional information, or may be a condition that can be satisfied by both the model input information and the additional information.

The additional information is information included in the prediction target information and the evaluation information and is not input to the model f_1. For example, in a case where the model input information includes a store periphery image, examples of the additional information include a resolution of the store periphery image, a photographing time, a type of a photographing device, a photographer, or a combination thereof. However, examples of the model input information and the additional information are not limited thereto. The prediction target information and the evaluation information only need to include at least the model input information, and do not necessarily include the additional information. However, in a case where a plurality of conditions to be described later is determined with reference to the additional information, both the prediction target information and the evaluation information include the model input information and the additional information.

The weight vector and the condition are not necessarily limited to a one-to-one basis, but here, an example of one-to-one basis will be mainly described, and a condition of one-to-one basis with the weight vector w_j will be described as a condition c_j. In other words, the weight vector w_j is associated with the condition c_j. In a case where the weight vector w_j and the condition c_j are relevant to each other on a one-to-one basis, the number of the plurality of conditions c_j is equal to the number Nweight of the weight vectors.

### (Prediction Unit 12)

The prediction unit 12 is configured similarly to the above-described example embodiment, and also outputs a prediction result obtained by integrating prediction results predicted by the plurality of models f_i with reference to model input information included in prediction target information related to the prediction target, using the weight vector w_j selected based on the prediction target information among the plurality of weight vectors w_j.

More specifically, the prediction unit 12 selects the weight vector w_j associated with the condition c_j satisfied by the prediction target information among the plurality of conditions c_j. The prediction unit 12 outputs a prediction result obtained by integrating the prediction results y_i output from each of the plurality of models f_i with respect to the model input information included in the prediction target information using the selected weight vector w_j. For example, the processing of calculating the integrated prediction result is expressed by the following Expression (10).

$$\begin{matrix}[ Math . 8 ] & \\ \hat{y} = {\sum }_{i = 1}^{{N}^{model}} w \_ j \_if \_i ( x ) & ( 10 )\end{matrix}$$

In Expression (10), the left side (hereinafter, described as y\hat{ }) indicates an integrated prediction result. x represents model input information included in the prediction target information. f_i (x) represents a prediction result y_i by the model f_i. w_j_i is an element relevant to the model f_i among elements of the weight vector w_j associated with the condition c_j satisfied by the model input information.

In Expression (10), in a case where the condition c_j(x) is True, that is, in a case where x satisfies the condition c_j, the prediction unit 12 calculates the integrated prediction result using the weight w_j relevant to the condition c_j. The weight w_j is a normalized value.

In a case where the prediction target information includes the additional information, the prediction unit 12 may select any one of the plurality of weight vectors w_j based on the model input information and the additional information included in the prediction target information. In this case, w_j_i in Expression (10) may be an element relevant to the model f_i among elements of the weight vector w_j associated with the condition c_j satisfied by one or both of the model input information and the additional information.

For example, an example in which the prediction target information includes a store periphery image and a weekday/holiday label as the model input information, and includes the resolution of the store periphery image as the additional information will be described. In this example, the condition c_1 may be “weekday and high resolution”, the condition c_2 may be “weekday and low resolution”, the condition c_3 may be “holiday and high resolution”, and the condition c_4 may be “holiday and low resolution”. In this case, the number Nweight of the weight vectors may be 4, which is the number of conditions.

For example, a set of prediction target information may be input to the prediction unit 12. Such a set X is expressed by the following Expression (11).

$$\begin{matrix}[ Math . 9 ] & \\ 𝒳 = {\{ {x}_{\_ k} \}}_{k = 1}^{{N}^{input}} & ( 11 )\end{matrix}$$

In Expression (11), x_k represents the k-th model input information included in the Ninput pieces of prediction target information. In a case where the prediction target information includes the additional information, Expression (11) is similarly described by replacing “x_k” with “x_k, v_k”. v_k indicates additional information included in the k-th prediction target information.

In this case, the prediction unit 12 outputs a set Y of integrated prediction results relevant to the set X. Such a set Y is expressed by the following Expression (12).

$$\begin{matrix}[ Math . 10 ] & \\ 𝒴 = {\{ \}}_{k = 1}^{{N}^{input}} & ( 12 )\end{matrix}$$

In Expression (12), y\hat{ }_k represents an integrated prediction result relevant to the k-th prediction target information.

### (Weight Update Unit 11)

The weight update unit 11 is configured similarly to the above-described example embodiment, and also updates some or all of the plurality of weight vectors w_j based on an evaluation result obtained by evaluating performance of each of the plurality of models f_i with reference to evaluation information including model input information for evaluation obtained over time after the operation of the plurality of models f_i included in the model pool MP is started, and the evaluation information.

More specifically, the weight update unit 11 updates the weight vector w_j associated with the condition c_j satisfied by the evaluation information among the plurality of conditions c_j. For example, in a case where the model input information for evaluation included in the evaluation information includes a weekday/holiday label indicating a weekday, the evaluation information satisfies a condition c_1 “weekday”. Therefore, the weight update unit 11 sets the weight vector w_1 associated with the condition c_1 as an update target.

Here, a case where the model input information included in the prediction target information referred to by the prediction unit 12 in the past prediction processing is applied as the model input information for evaluation included in the evaluation information will be described. For example, the weight update unit 11 may use the model input information as the model input information for evaluation in response to acquisition of a true value (for example, the sales actual value of the target date) relevant to the model input information (for example, store periphery image of target date and weekday/holiday label) referred to by the prediction unit 12 in the past. In this case, the weight update unit 11 may acquire the evaluation information including the model input information for evaluation and the true value. However, the model input information for evaluation included in the evaluation information only needs to be information over time after the operation of the plurality of models f_i is started, and is not limited to the above-described example.

The weight update unit 11 may update some or all of the plurality of weight vectors w_j based on the plurality of pieces of evaluation information and the evaluation result of the performance of each model f_i with reference to the plurality of pieces of evaluation information. The performance evaluation result of each model f_i with reference to the plurality of pieces of evaluation information may be, for example, a statistical value (for example, an average value, a maximum value, a minimum value, and the like) of the performance evaluation result of each model f_i with reference to each piece of evaluation information.

In a case where the additional information for evaluation is included in the evaluation information, the weight update unit 11 may update some or all of the plurality of weight vectors w_k based on the evaluation result of the performance of each model f_i with reference to the evaluation information, and the model input information for evaluation and the additional information for evaluation included in the evaluation information.

For example, a set Deval of pieces of evaluation information input to the weight update unit 11 is expressed by the following Expression (13).

$$\begin{matrix}[ Math . 11 ] & \\ {𝒟}^{eval} = {\{ ( {x}_{\_ l} , {y}_{\_ l} ) \}}_{l = 1}^{{N}^{eval}} & ( 13 )\end{matrix}$$

In Expression (13), x_1 represents model input information included in the 1-th evaluation information among the Neval pieces of evaluation information, and y_1 represents a true value included in the 1-th evaluation information. In a case where the additional information for evaluation is included in the evaluation information, Expression (13) is similarly described by replacing “x_1, y_1” with “x_1, y_1, v_1”. v_1 indicates additional information for evaluation included in the 1-th evaluation information.

For example, for at least one of the plurality of conditions c_j, the weight update unit 11 may extract one or more pieces of evaluation information satisfying the condition c_j from the plurality of pieces of evaluation information.

The processing of extracting one or more pieces of evaluation information satisfying the condition c_j is expressed by, for example, the following Expression (14).

$$\begin{matrix}[ Math . 12 ] & \\ {𝒟}_{\_ j}^{eval} := \{ ( x , y ) ∈ {𝒟}^{eval} \vert {c}_{\_ j} ( x ) \} & ( 14 )\end{matrix}$$

In Expression (14), the left side (hereinafter, also described as Deval_j) is a subset of Deval and indicates a set of evaluation information satisfying the condition c_j.

The weight update unit 11 updates the weight vector w_j associated with the condition c_j based on the evaluation result obtained by evaluating the performance of each model f_i using the one or more pieces of extracted evaluation information (Deval_j). In a case where the additional information for evaluation is included in the evaluation information, Expression (14) is similarly described by replacing c_j(x) with c_j(x, v). c_j(x, v) is true in a case where the model input information x for evaluation and the additional information v for evaluation included in the evaluation information satisfy the condition c_j, and is false in a case where they do not satisfy the condition c_j.

For example, it is assumed that five pieces of evaluation information are included in the set Deval, the weekday/holiday label included in the model input information for evaluation of three pieces of evaluation information is “weekday”, and the weekday/holiday label included in the model input information for evaluation of the remaining two pieces of evaluation information is “holiday”. In this case, the former three pieces of evaluation information satisfying the condition c_1 “weekday” are extracted as the subset Deval_1. The latter two pieces of evaluation information satisfying the condition c_2 “holiday” are extracted as the subset Deval_2.

For example, in a case where the performance evaluation result of each model f_i is represented by a numerical value, the weight update unit 11 may adopt the numerical value of the evaluation result of the performance as it is as the element w_j_i of the weight vector w_j to be updated. The processing is expressed by the following Expression (15), for example.

$$\begin{matrix}[ Math . 13 ] & \\ {w}_{\_ j \_ i} = Acc ( {f}_{\_ i} , {𝒟}_{\_ j}^{eval} ) & ( 15 )\end{matrix}$$

The right side of Expression (15) indicates an evaluation result obtained by evaluating the performance of each of the models f_i using the subset Deval_j described above. As described above, for example, the evaluation result may be a statistical value of an evaluation result obtained by evaluating the model f_i using each piece of evaluation information included in the subset Deval_j.

As a specific example, it is assumed that the plurality of pieces of evaluation information include evaluation information satisfying a condition c_1 “weekday” and evaluation information satisfying a condition c_2 “holiday”. At this time, the weight update unit 11 may update a numerical value of the evaluation result obtained by evaluating the performance of each model f_i with reference to the subset Deval_1 of the evaluation information satisfying the condition c_1 “weekday” as the element w_1_i of the weight vector w_1 associated with the condition c_1. The weight update unit 11 may update a numerical value of an evaluation result obtained by evaluating the performance of each model f_i with reference to the subset Deval_2 of the evaluation information satisfying the condition c_2 “holiday” as the element w_2_i of the weight vector w_2 associated with the condition c_2.

### (Display Information Generation Unit 15)

The display information generation unit 15 is configured as follows in addition to the configuration similarly to the above-described example embodiment. The display information generation unit 15 generates display information including at least one of the plurality of conditions c_j, the weight w_j_i of each of the plurality of models f_i in each of the plurality of conditions c_j, and information obtained from the weight w_j_i. An example of the display information generated by the display information generation unit 15 will be described later.

### (Flow of Prediction Method)

A prediction method S1B executed by the prediction device 1B configured as described above will be described substantially similarly to the prediction method SIA described with reference to FIG. 4. However, the details of the weight update processing S11, the details of the prediction processing S12, and the details of the display information generation processing S15 are different.

### (Detailed Flow of Weight Update Processing)

First, a detailed flow of the weight update processing S11 will be described with reference to FIG. 10. FIG. 10 is a flowchart for explaining an example of a detailed flow of the weight update processing S11. As illustrated in FIG. 10, the weight update processing S11 includes steps S111B to S115B.

In step S111B, the weight update unit 11 acquires a set Deval of pieces of evaluation information. For example, in a case where the prediction method S1B has been executed in the past, the weight update unit 11 may acquire the evaluation information including the model input information included in the prediction target information used in the past prediction processing S12 as the model input information for evaluation. Once the number of unprocessed pieces of evaluation information among the acquired pieces of evaluation information reaches a predetermined number, the weight update unit 11 may execute the processing of the next step S112B and subsequent steps using the set Deval of the predetermined number of pieces of evaluation information. The set Deval of evaluation information only needs to include at least one piece of evaluation information, and is not limited to including a plurality of pieces of evaluation information. An example of the set Deval is as described with reference to Expression (13).

In step S112B, the weight update unit 11 extracts a subset Deval_j of the evaluation information satisfying a certain condition c_j from the set Deval. An example of the subset Deval_j of the evaluation information is as described with reference to Expression (14).

In step S113B, the weight update unit 11 evaluates the performance of each model f_i using the subset Deval_j of the evaluation information.

In step S114B, the weight update unit 11 updates the weight vector w_j associated with the condition c_j based on the evaluation result of the performance of each model f_i using the subset Deval_j. An example of processing of updating the weight vector w_j is as described with reference to Expression (15).

In step S115B, the weight update unit 11 determines whether the evaluation information satisfying another condition c_j that has not yet been processed is included in the set Deval of evaluation information. In a case where the evaluation information satisfying another condition c_j is included (Yes in step S115B), the processing from step S112B is repeated. In a case where the evaluation information satisfying another condition c_j is not included, the weight update processing S11 ends.

Then, the next prediction processing S12 is executed using the plurality of weight vectors w_j partially or entirely updated by the weight update processing S11.

### (Detailed Flow of Prediction Processing)

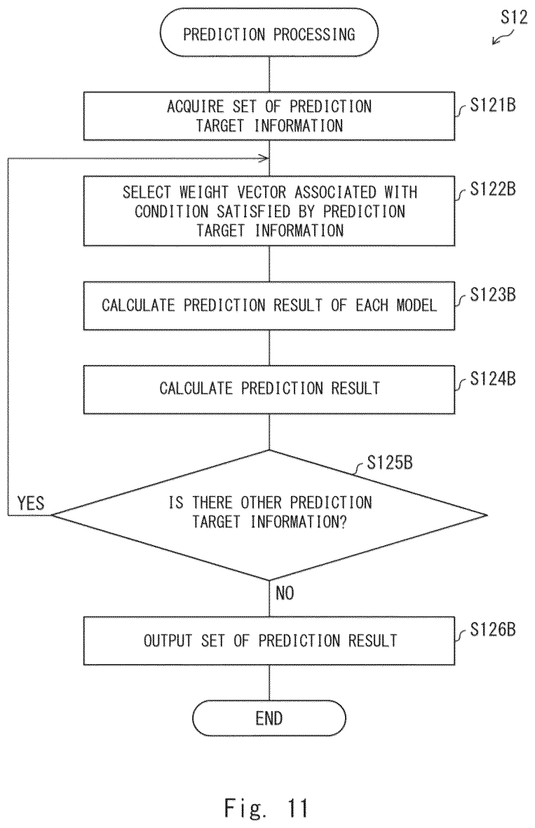

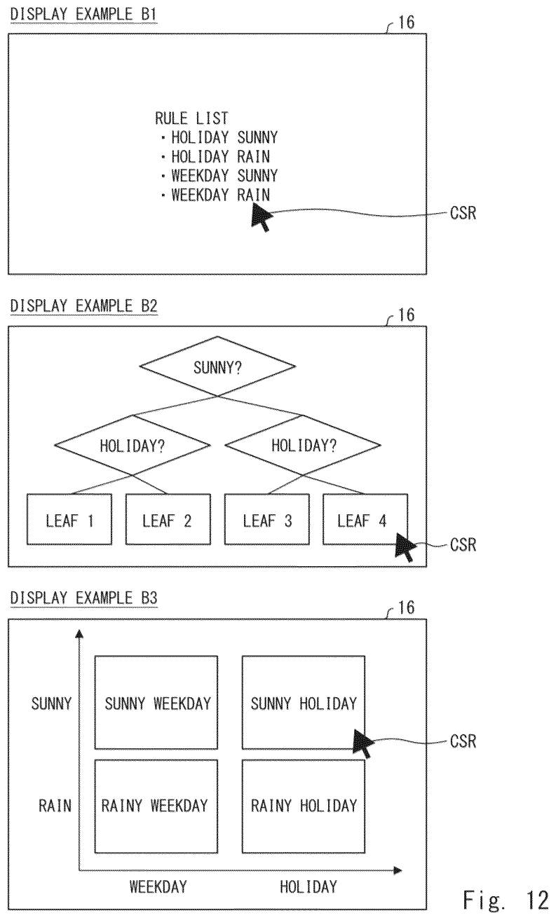

Next, details of the prediction processing S12 will be described with reference to FIG. 11. FIG. 11 is a flowchart illustrating an example of a detailed flow of the prediction processing S12. As illustrated in FIG. 11, the prediction processing S12 includes steps S121B to S126B.

In step S121B, the prediction unit 12 acquires a set X of prediction target information. The prediction unit 12 may acquire a set X of prediction target information stored in a memory included in the prediction device 1B, or may acquire a set X of prediction target information received via a network. The set X of prediction target information only needs to include at least one piece of prediction target information, and is not limited to including a plurality of pieces of prediction target information. An example of the set X is as described with reference to Expression (11) and the like.

In step S122B, the prediction unit 12 selects the weight vector w_j associated with the condition c_j satisfied by the prediction target information.

In step S123B, the prediction unit 12 obtains the prediction result y_i output from each model f_i by inputting the model input information included in the prediction target information to each model f_i.

In step S124B, the prediction unit 12 calculates a prediction result y\hat{ } obtained by integrating the prediction results y_i by the models f_i using the selected weight vector w_j. An example of the calculation processing of y\hat{ } is as described with reference to Expression (10).

In step S125B, the prediction unit 12 determines whether the set X includes other prediction target information for which the integrated prediction result has not been calculated yet. In a case where other prediction target information is included (Yes in step S125B), the processing from step S122B is repeated for the other prediction target information. In a case where the other prediction target information is not included, the processing of the next step S126B is executed.

In step S126B, the prediction unit 12 outputs a set Y of integrated prediction results relevant to each piece of prediction target information. An example of the set Y is as described with reference to Expression (12). The next weight update processing S11 may be executed using the evaluation information including the model input information included in the prediction target information used in the prediction processing S12 as the model input information for evaluation. However, similarly to the second example embodiment, the weight update processing S11 and the prediction processing S12 may be executed independently of each other, and the execution order and the execution timing of each processing are not defined.

### (Example of Display Information Generation Processing S15)

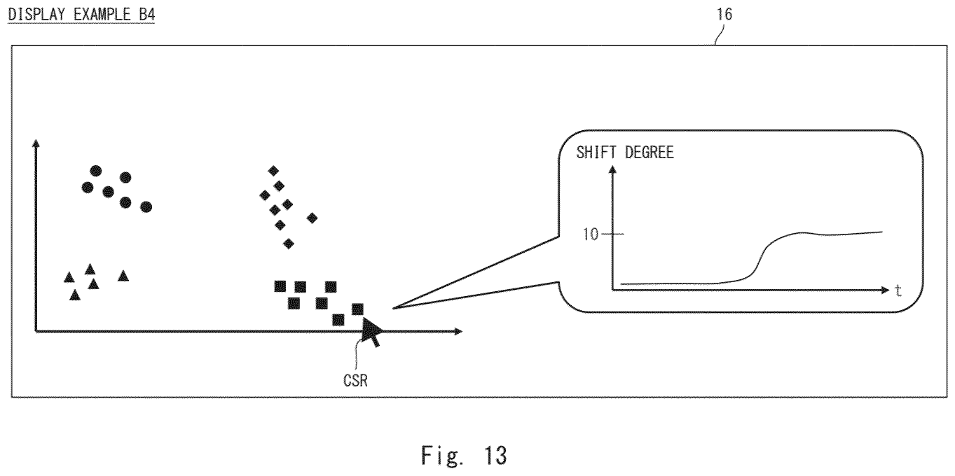

An example of the display information generated by the display information generation unit 15 executing the display information generation processing S15 will be described with reference to FIGS. 12 and 13. FIG. 12 is a diagram illustrating display examples B1 to B3. FIG. 13 is a diagram illustrating a display example B4.

As described above, the display information generation unit 15 generates display information including the plurality of conditions c_j. As an example, in the case of the condition c_1 “holiday sunny”, the condition c_2 “holiday rain”, the condition c_3 “weekday sunny”, and the condition c_4 “weekday rain”, the display information generation unit 15 generates the display information including the conditions c_1 to c_4 as a list as illustrated in the display example B1 of FIG. 12.

The input/output unit 16 may display a cursor CSR operable by the user, and may be configured to be able to select a condition. In this configuration, the display information generation unit 15 may be configured to generate display information including additional information to be presented to the user based on an input from the user. Examples of the additional information include the weight w_j_i of each of the plurality of models f_i under the selected condition c_j and information obtained from the weight w_j_i. For example, the display information generation unit 15 generates display information including the shift degree of the display example A2 and the flip degree of the display example A4 described above as the additional information.

For example, as illustrated in the display example B1, in a case where the user operates the cursor CSR and selects the condition c_4 “weekday rain”, the display information generation unit 15 generates display information including the weight w_j_i of each of the plurality of models f_i under the selected condition c_4 “weekday rain” and information obtained from the weight w_j_i.

As another example, as illustrated in a display example B2 in FIG. 12, the display information generation unit 15 generates display information including a tree structure indicating branch rules of the conditions c_1 to c_4. In the display example B2, the condition c_j is displayed in each of “leaf 1” to “leaf 4” of the lowermost layer.

Similarly in the display example B2, for example, in a case where the user operates the cursor CSR and selects the condition of “leaf 4”, the display information generation unit 15 generates display information including the weight w_j_i of each of the plurality of models f_i under the selected condition of “leaf 4” and information obtained from the weight w_j_i.

As still another example, the display information generation unit 15 generates display information including information obtained by dividing the conditions c_1 to c_4 on the feature space as illustrated in a display example B3 of FIG. 12. In the display example B3, whether the feature of the condition is “sunny weekday”, “rainy weekday”, “sunny holiday”, and “rainy holiday” is displayed in the characteristic space.

Furthermore, similarly in the display example B3, in a case where the user operates the cursor CSR and selects the condition “sunny holiday”, the display information generation unit 15 generates display information including the weight w_j_i of each of the plurality of models f_i under the selected condition “sunny holiday” and information obtained from the weight w_j_i.

As still another example, as illustrated in a display example B4 of FIG. 13, the display information generation unit 15 generates display information including a plurality of data points obtained by embedding the model input information (explanatory variable) in the low-dimensional space (two-dimensional space in the case of FIG. 13).

In the display example B4 illustrated in FIG. 13, data points indicated by the model input information are illustrated using markers having different shapes for each condition satisfied by the model input information. As an example, a data point indicated using a round marker indicates a data point indicated by the model input information (explanatory variable) satisfying the condition c_1, and a data point indicated using a diamond marker indicates a data point indicated by the model input information (explanatory variable) satisfying the condition c_2.

As illustrated in FIG. 13, the input/output unit 16 may be configured to display a cursor CSR operable by the user and to select each data point. Also in this configuration, the display information generation unit 15 may be configured to generate display information including additional information to be presented to the user based on an input from the user. Examples of the additional information include the weight w_j_i of each of the plurality of models f_i under the selected condition c_j and information obtained from the weight w_j_i. For example, the display information generation unit 15 generates display information including the shift degree of the display example A2 and the flip degree of the display example A4 described above as the additional information. As an example, as illustrated in FIG. 13, in a case where the user operates the cursor CSR and selects the condition c_4, the display information generation unit 15 generates the display information including the shift degree in the condition c_4.

### (Effects of Prediction Device 1B)

As described above, the prediction device 1B adopts a configuration in which the prediction target information further includes the additional information not input to each model in addition to the model input information, and the evaluation information further includes the additional information for evaluation in addition to the model input information for evaluation. With this configuration, the weight update unit 11 updates some or all of the plurality of weight vectors based on the evaluation result, and the model input information for evaluation and the additional information for evaluation. The prediction unit 12 obtains an integrated prediction result by selecting one of the plurality of weight vectors based on the model input information and the additional information included in the prediction target information. Therefore, according to the prediction device 1B, in addition to the effects of the prediction device 1 and the prediction device 1A, by referring to the model input information and the additional information, prediction can be performed with high accuracy even in a case where a distribution shift different for each condition occurs.

The prediction device 1B generates display information including at least one of the plurality of conditions c_j, the weight w_j_i of each of the plurality of models f_i in each of the plurality of conditions c_j, and information obtained from the weight w_j_i. Therefore, according to the prediction device 1B, it is possible to present to the user what kind of distribution shift has occurred in each of the plurality of conditions c_j over time.

### Fourth Example Embodiment

A fourth example embodiment that is an example of an example embodiment of the present disclosure will be described in detail with reference to the drawings. Components having the same functions as the components described in the above-described example embodiments are denoted by the same reference signs, and the description thereof will be appropriately omitted. The application range of each technical means adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### (Outline of Prediction Device 1C)

A prediction device 1C updates some or all of the plurality of first weight vectors w⁽¹⁾_j and some or all of the plurality of second weight vectors w⁽²⁾_k based on the evaluation result obtained by evaluating the performance of each of the plurality of models f_i with reference to the evaluation information including the model input information for evaluation and the evaluation information. The second weight vector w⁽²⁾_k is a vector having a weight given to each of the first weight vectors w⁽¹⁾_j as a component.

The prediction device 1C outputs a prediction result obtained by integrating the prediction results predicted by the models f_i with reference to the model input information included in the prediction target information related to the prediction target using the weight vector selected based on the prediction target information among the plurality of first weight vectors w⁽¹⁾_j and the plurality of second weight vectors w⁽²⁾_k.

Here, the second weight vector w⁽²⁾_k selected based on the prediction target information is, for example, one vector. The first weight vector w⁽¹⁾_j selected according to the selected second weight vector w⁽²⁾_k may be one vector or a plurality of vectors.

### (Configuration of Prediction Device 1C)

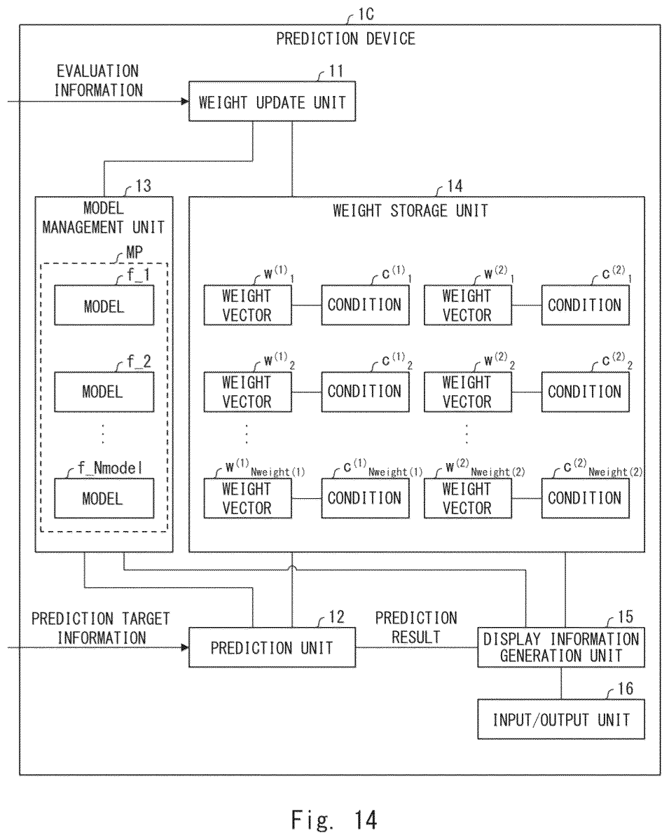

A configuration of the prediction device 1C will be described with reference to FIG. 14. FIG. 14 is a block diagram illustrating a configuration of the prediction device 1C. As illustrated in FIG. 14, the prediction device 1C includes a weight update unit 11, a prediction unit 12, a model management unit 13, a weight storage unit 14, a display information generation unit 15, and an input/output unit 16. The weight update unit 11, the prediction unit 12, the model management unit 13, and the display information generation unit 15 implement an update means, a prediction means, a management means, and a display information generation means, in the present example embodiment.

Since the model management unit 13 and the input/output unit 16 have the same configurations as those of the above-described example embodiment, the description thereof will be omitted.

### (Weight Storage Unit 14)

The weight storage unit 14 stores: Nweight(1) first weight vectors w⁽¹⁾_1, w⁽¹⁾_2, . . . , w⁽¹⁾_Nweight(1); and Nweight(2) second weight vectors w⁽²⁾_1, w⁽²⁾_2, . . . , w⁽²⁾_Nweight(2). Here, for Nweight(1) and Nweight(2), as an example, w⁽¹⁾_j which is a natural number of 2 or more may be written as w⁽¹⁾ⱼ, or w⁽²⁾_k may be written as w⁽²⁾ₖ. In other words, the weight storage unit 14 stores a first weight set W⁽¹⁾ expressed by the following Expression (16) and a second weight set W⁽²⁾ expressed by the following Expression (17).

$$\begin{matrix}[ Math . 14 ] & \\ {𝒲}^{( 1 )} = {\{ {w}_{j}^{( 1 )} \}}_{j = 1}^{{N}^{weight ( 1 )}} & ( 16 )\end{matrix}$$

$$\begin{matrix}[ Math . 15 ] & \\ {𝒲}^{( 2 )} = {\{ {w}_{k}^{( 2 )} \}}_{k = 1}^{{N}^{weight ( 2 )}} & ( 17 )\end{matrix}$$

### (First Weight Vector)

The first weight vector w⁽¹⁾_j is a vector having Nmodel weights w⁽¹⁾_j_i as elements (also denoted as w⁽¹⁾ⱼᵢ or w⁽¹⁾_{j,i}), and is expressed by the following Expression (18).

$$\begin{matrix}[ Math . 16 ] & \\ {w}_{j}^{( 1 )} = ( {w}_{j 1}^{( 1 )} , {w}_{j 2}^{( 1 )} , … , {w}_{j N model}^{( 1 )} ) & ( 18 )\end{matrix}$$

Here, the weight w⁽¹⁾_j_i represents a weight given to the model f_i in a case where the first weight vector w⁽¹⁾_j is selected. The weight vector w⁽¹⁾_j may be updated by the weight update unit 11, and the initial value of each element is arbitrarily determined. For example, the initial values of the elements may all be equal, or may be randomly determined.

Each of the plurality of first weight vectors w⁽¹⁾_j stored in the weight storage unit 14 is associated with at least one of a plurality of first conditions that can be satisfied by the prediction target information and can be satisfied by the evaluation information. Here, for certain prediction target information, there may be a plurality of the first conditions c⁽¹⁾_j satisfied by the prediction target information. Each of the plurality of first conditions c⁽¹⁾_j may be a condition that can be satisfied by the model input information. As an example, in a case where the model input information includes a weekday/holiday label and a weather label, a condition c⁽¹⁾_1 “sunny weekday” and a condition c⁽¹⁾_2 “sunny holiday” may be set as the plurality of first conditions c⁽¹⁾_1 and c⁽¹⁾_2. In a case where the evaluation information and the prediction target information include the additional information, each of the plurality of first conditions c⁽¹⁾_j may be a condition that can be satisfied by the additional information, or may be a condition that can be satisfied by both the model input information and the additional information.

Here, the first weight vector and the first condition are not necessarily relevant to each other on a one-to-one basis, but here, an example on a one-to-one basis will be mainly described, and the first condition on a one-to-one basis with the first weight vector w⁽¹⁾_j will be described as a first condition c⁽¹⁾_j. In other words, the first weight vector w⁽¹⁾_j is associated with the first condition c⁽¹⁾_j. In a case where the first weight vector w⁽¹⁾_j and the first condition c⁽¹⁾_j are relevant to each other on a one-to-one basis, the number of the plurality of first conditions c⁽¹⁾_j is equal to the number of first weight vectors Nweight(1). The first condition c⁽¹⁾_j is also referred to as c⁽¹⁾ⱼ.

### (Second Weight Vector)

On the other hand, the second weight vector w⁽²⁾_k is a vector having Nweight(1) weights w⁽²⁾_k_j as elements (also denoted as w⁽²⁾ₖⱼ or w⁽²⁾_{k,j}), and is expressed by the following Expression (19).

$$[ Math . 17 ]$$

$${w}_{k}^{( 2 )} = ( {w}_{k 1}^{( 2 )} , {w}_{k 2}^{( 2 )} , … , {w}_{kNweight ( 1 )}^{( 2 )} ) \qquad ( 19 )$$

Here, the weight w⁽²⁾_k_j represents a weight given to the first weight vector w⁽¹⁾_j in a case where the second weight vector w⁽¹⁾_k is selected. The weight vector w⁽²⁾_k may be updated by the weight update unit 11, and the initial value of each element is arbitrarily determined. For example, the initial values of the elements may all be equal, or may be randomly determined.

Each of the plurality of second weight vectors w⁽²⁾_k stored in the weight storage unit 14 is associated with at least one of a plurality of second conditions that can be satisfied by the prediction target information and can be satisfied by the evaluation information. Here, for certain prediction target information, the second condition c⁽²⁾_k satisfied by the prediction target information may be configured to be determined as one. Each of the plurality of second conditions c⁽²⁾_k may be a condition that can be satisfied by the model input information. The plurality of second conditions c⁽²⁾_k may include the same condition as the above-described first condition c⁽¹⁾_j. As an example, in a case where the model input information includes a weekday/holiday label and a weather label, a condition c⁽²⁾_1 “sunny weekday” and a condition c⁽²⁾_2 “sunny holiday” may be set as the plurality of first conditions c⁽²⁾_1 and c⁽²⁾_2. In a case where the evaluation information and the prediction target information include the additional information, each of the plurality of second conditions c⁽²⁾_k may be a condition that can be satisfied by the additional information, or may be a condition that can be satisfied by both the model input information and the additional information.

Here, the second weight vector and the second condition are not necessarily relevant to each other on a one-to-one basis, but here, an example of one-to-one basis will be mainly described, and the second condition relevant to the second weight vector w⁽²⁾_k on a one-to-one basis will be described as a second condition c⁽²⁾_k. In other words, the second weight vector w⁽²⁾_k is associated with the second condition c⁽²⁾_k. In a case where the second weight vector w⁽²⁾_k and the second condition c⁽²⁾_k are relevant to each other on a one-to-one basis, the number of the plurality of second conditions c⁽²⁾_k is equal to the number Nweight(2) of the second weight vectors. The second condition c⁽²⁾_k is also referred to as c⁽²⁾_k.

As described above, the second weight vector w⁽²⁾_k is a vector in which the weight given to the first weight vector w⁽¹⁾_j is the component w⁽²⁾_k_j. Therefore, the second weight vector w⁽²⁾_k can also be expressed as a weight vector for soft-determination as to which of the plurality of first weight vectors w⁽¹⁾_j to use in the prediction processing. Here, “soft-determine” refers to, as an example, using a plurality of first weight vectors w⁽¹⁾_j in combination using multistage coefficients.

In the present example embodiment, the plurality of first weight vectors w⁽¹⁾_j may include a weight vector associated with a condition relevant to a logical sum of any two or more conditions included in the plurality of first conditions c⁽¹⁾_j.

### (Prediction Unit 12)

The prediction unit 12 is configured similarly to the above-described example embodiment, and also outputs a prediction result obtained by integrating prediction results predicted by each model f_i with reference to model input information included in prediction target information related to a prediction target, using a weight vector selected based on the prediction target information among a plurality of first weight vectors and a plurality of second weight vectors.

More specifically, the prediction unit 12 selects the second weight vector w⁽²⁾_k associated with the second condition c⁽²⁾_k satisfied by the prediction target information among the plurality of second conditions c⁽²⁾_k. The prediction unit 12 outputs a result obtained by integrating the prediction results y_i output from each of the plurality of models f_i with respect to the model input information included in the prediction target information by using a combination of the selected second weight vector w⁽²⁾_k and the first weight vector w⁽¹⁾_j indirectly selected by the selected second weight vector w⁽²⁾_k. For example, in the case of the regression task, the processing of calculating the integrated prediction result is expressed by the following Expression (20).

$$[ Math . 18 ]$$

$$\hat{y} = {\sum }_{j} {w}_{k , j}^{( 2 )} {\sum }_{i} {w}_{j , i}^{( 1 )} {f}_{i} ( x ) \qquad ( 20 )$$

In Expression (20), the left side (hereinafter, described as y\hat{ }) indicates an integrated prediction result. x represents model input information included in the prediction target information. f₁ (x) represents a prediction result yᵢ by the model f₁. w⁽²⁾_{k,j} is an element associated with the first weight vector w⁽¹⁾ⱼ among elements of the second weight vector w⁽²⁾_k associated with the second condition c⁽²⁾_k satisfied by the model input information. w⁽¹⁾_{j,i} is an element relevant to the model fᵢ among the elements of the first weight vector w⁽¹⁾ⱼ.

In Expression (20), it is assumed that each weight vector is normalized, as follows.

$$[ Math . 19 ]$$

$${\sum }_{j} {w}_{k , j}^{( 2 )} = 1$$

$${\sum }_{i} {w}_{j , i}^{( 1 )} = 1$$

In the case of the classification task, as an example, fᵢ(ₓ) represents a vector of a class number dimension, and the prediction probability for each class label i is expressed by fᵢ(ₓ). Then, the prediction unit 12 can calculate the post-integration prediction probability using the same expression as the above Expression (20). In a case where a label is finally determined as a prediction value, the prediction unit 12 determines a class label having the highest probability as the label as the prediction value.

In a case where the prediction target information includes the additional information, the prediction unit 12 may select any one of the plurality of second weight vectors w⁽²⁾ₖ based on the model input information and the additional information included in the prediction target information. In this case, w⁽²⁾_{k,j} in Expression (20) may be an element associated with the first weight vector w⁽¹⁾ⱼ among the elements of the second weight vector w⁽²⁾ₖ associated with the second condition c⁽²⁾ₖ satisfied by one or both of the model input information and the additional information.

For example, an example in which the prediction target information includes a store periphery image and a weekday/holiday label as the model input information, and includes the resolution of the store periphery image as the additional information will be described. In this example, the second condition c⁽²⁾₁ may be “weekday and high resolution”, the second condition c⁽²⁾₂ may be “weekday and low resolution”, the second condition c⁽²⁾₃ may be “holiday and high resolution”, and the second condition c⁽²⁾₄ may be “holiday and low resolution”. In this case, the number Nweight(2) of the second weight vectors may be 4, which is the number of conditions.

For example, a set of prediction target information may be input to the prediction unit 12. Such a set X is expressed by the following Expression (22).

$$[ Math . 20 ]$$

$$𝒳 = {\{ ( {x}_{m} , {v}_{m} ) \}}_{m = 1}^{{N}^{input}} \qquad ( 22 )$$

In Expression (22), xₘ represents m-th model input information included in Ninput pieces of prediction target information. vₘ indicates m-th additional information included in the Ninput pieces of prediction target information.

In this case, the prediction unit 12 outputs a set Y of integrated prediction results relevant to the set X. Such a set Y is expressed by the following Expression (23).

$$[ Math . 21 ]$$

$$\hat{𝓎} = {\{ \}}_{m = 1}^{{N}^{input}} \qquad ( 23 )$$

In Expression (23), y\hat{ }ₘ represents an integrated prediction result relevant to the m-th prediction target information.

### (Weight Update Unit 11)

The weight update unit 11 is configured similarly to the above-described example embodiment, and also updates some or all of the plurality of weight vectors based on an evaluation result obtained by evaluating performance of each of the plurality of models f_i with reference to evaluation information including model input information for evaluation obtained over time after the operation of the plurality of models f_i included in the model pool MP is started, and the evaluation information.

More specifically, the weight update unit 11 updates the first weight vector w⁽¹⁾_j associated with the first condition c⁽¹⁾_j satisfied by the evaluation information among the plurality of first conditions c⁽¹⁾_j. For example, in a case where the model input information for evaluation included in the evaluation information includes a weekday/holiday label indicating a weekday and a weather label indicating sunny, the evaluation information satisfies the first condition c⁽¹⁾_1 “sunny weekday”. Therefore, the weight update unit 11 sets the first weight vector w⁽¹⁾_1 associated with the first condition c⁽¹⁾_1 as an update target.

The weight update unit 11 updates the second weight vector w⁽²⁾_k associated with the second condition c⁽²⁾_k satisfied by the evaluation information among the plurality of second conditions c⁽²⁾_k. For example, in a case where the model input information for evaluation included in the evaluation information includes a weekday/holiday label indicating a weekday and a weather label indicating sunny, the evaluation information satisfies the second condition c⁽²⁾_1 “sunny weekday”. Therefore, the weight update unit 11 sets the second weight vector w⁽²⁾_1 associated with the second condition c⁽²⁾_1 as an update target.

The weight update unit 11 may update some or all of the plurality of first weight vectors w⁽¹⁾_j and some or all of the plurality of second weight vectors w⁽²⁾_k based on the plurality of pieces of evaluation information and the evaluation result of the performance of each model f_i with reference to the plurality of pieces of evaluation information. The performance evaluation result of each model f_i with reference to the plurality of pieces of evaluation information may be, for example, a statistical value (for example, an average value, a maximum value, a minimum value, and the like) of the performance evaluation result of each model f_i with reference to each piece of evaluation information.

In a case where the additional information for evaluation is included in the evaluation information, the weight update unit 11 may update some or all of the plurality of first weight vectors w⁽¹⁾_j and some or all of the plurality of second weight vectors w⁽²⁾_k based on the evaluation result of the performance of each model f_i with reference to the evaluation information, and the model input information for evaluation and the additional information for evaluation included in the evaluation information.

For example, a set Deval of pieces of evaluation information input to the weight update unit 11 is expressed by the following Expression (24).

$$[ Math . 22 ]$$

$${𝒟}^{eval} = {\{ ( {x}_{n} , {y}_{n} , {v}_{n} ) \}}_{n = 1}^{{N}^{eval}} \qquad ( 24 )$$

In Expression (24), xₙ represents model input information included in the n-th evaluation information among the Neval pieces of evaluation information, and yₙ represents a true value included in the n-th evaluation information. vₙ indicates additional information for evaluation included in the n-th evaluation information among the Neval-pieces of evaluation information. The value of Neval may be 1.

For example, for at least one of the plurality of first conditions c⁽¹⁾_j, the weight update unit 11 may extract one or more pieces of evaluation information satisfying the first condition c⁽¹⁾_j from the plurality of pieces of evaluation information. The processing of extracting one or more pieces of evaluation information satisfying the first condition c⁽¹⁾_j is expressed by, for example, the following Expression (25).

$$[ Math . 23 ]$$

$${𝒟}_{j}^{( 1 ) eval} := \{ ( x , y , v ) ∈ {𝒟}^{eval} \vert {c}_{j}^{( 1 )} ( x , v ) \} \qquad ( 25 )$$

In Expression (25), the left side (hereinafter, also described as D(1)eval_j) is a subset of Deval and indicates a set of evaluation information satisfying the first condition c⁽¹⁾_j.

The weight update unit 11 updates the first weight vector w⁽¹⁾_j associated with the first condition c⁽¹⁾_j based on the evaluation result obtained by evaluating the performance of each model f_i using the one or more pieces of extracted evaluation information (D(1)eval_j). Expression (25) represents a case where the evaluation information includes the additional information for evaluation, and c⁽¹⁾_j(x, v) is true in a case where the model input information x for evaluation and the additional information v for evaluation included in the evaluation information satisfy the first condition c⁽¹⁾_j, and is false in a case where they do not satisfy the first condition c⁽¹⁾_j.

For example, it is assumed that five pieces of evaluation information are included in the set Deval, the weekday/holiday label included in the model input information for evaluation of three pieces of evaluation information is “weekday”, and the weekday/holiday label included in the model input information for evaluation of the remaining two pieces of evaluation information is “holiday”. In this case, the former three pieces of evaluation information satisfying the first condition c⁽¹⁾_1 “weekday” are extracted as the subset D(1)eval_1. The latter two pieces of evaluation information satisfying the first condition c⁽¹⁾_2 “holiday” are extracted as the subset D(1)eval_2.

Similarly, for at least one of the plurality of second conditions c⁽²⁾_k, the weight update unit 11 may extract one or more pieces of evaluation information satisfying the second condition c⁽²⁾_k from the plurality of pieces of evaluation information. The processing of extracting one or more pieces of evaluation information satisfying the second condition c⁽²⁾_k is expressed by, for example, the following Expression (26).

$$[ Math . 24 ]$$

$${𝒟}_{k}^{( 2 ) eval} := \{ ( x , y , v ) ∈ {𝒟}^{eval} \vert {c}_{k}^{( 2 )} ( x , v ) \} \qquad ( 26 )$$

In Expression (26), the left side (hereinafter, also described as D(2)eval_k) is a subset of Deval and indicates a set of evaluation information satisfying the second condition c⁽²⁾_k.

The weight update unit 11 updates the second weight vector w⁽²⁾_k associated with the second condition c⁽²⁾_k based on the evaluation result of evaluating the first weight vector using the one or more pieces of extracted evaluation information (D(2)eval_k). Expression (26) represents a case where the evaluation information includes the additional information for evaluation, and c⁽²⁾_k(x, v) is true in a case where the model input information x for evaluation and the additional information v for evaluation included in the evaluation information satisfy the second condition c⁽²⁾_k, and is false in a case where they do not satisfy the second condition c⁽²⁾_k.

For example, it is assumed that five pieces of evaluation information are included in the set Deval, the weekday/holiday label included in the model input information for evaluation of three pieces of evaluation information is “weekday”, and the weekday/holiday label included in the model input information for evaluation of the remaining two pieces of evaluation information is “holiday”. In this case, the former three pieces of evaluation information satisfying the second condition c⁽²⁾_1 “weekday” are extracted as the subset D(2)eval_1. The latter two pieces of evaluation information satisfying the second condition c⁽²⁾_2 “holiday” are extracted as the subset D(2)eval_2.

### (Display Information Generation Unit 15)

The display information generation unit 15 is configured similarly to the example embodiment described above, and generates display information with reference to the integrated prediction result derived by the prediction unit 12, the model pool MP, and the first weight vector and the second weight vector. An example of the display information generated by the display information generation unit 15 will be described later.

### (Flow of Prediction Method)

A prediction method SIC executed by the prediction device 1C configured as described above will be described substantially similarly to the prediction method SIA described with reference to FIG. 4. However, the details of the weight update processing S11, the details of the prediction processing S12, and the details of the display information generation processing S15 are different.

### (Detailed Flow of Weight Update Processing)

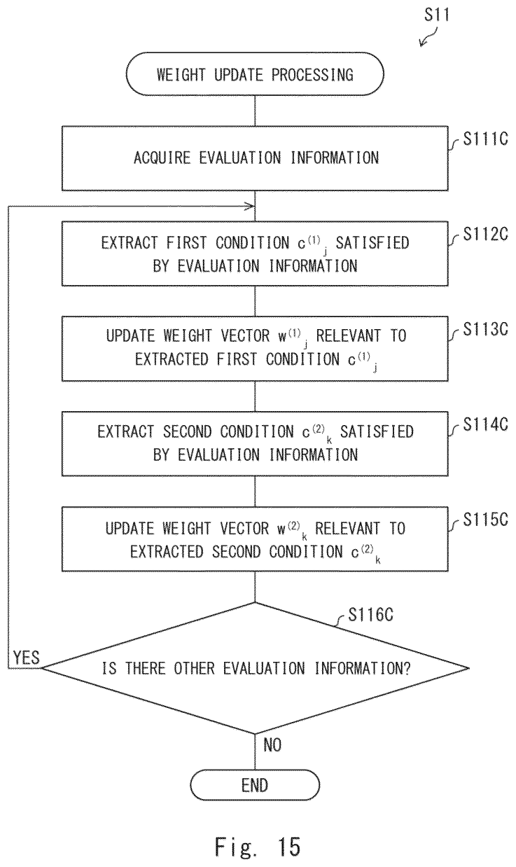

First, a detailed flow of the weight update processing S11 will be described with reference to FIG. 15. FIG. 15 is a flowchart for explaining an example of a detailed flow of the weight update processing S11. As illustrated in FIG. 15, the weight update processing S11 includes steps S111C to S116C.

### (Step S111C)

In step S111C, the weight update unit 11 acquires the evaluation information. For example, in a case where the prediction method SIA has been executed in the past, the weight update unit 11 may acquire the evaluation information including the model input information included in the prediction target information used in the past prediction processing S12 as the model input information for evaluation. Once the number of unprocessed pieces of evaluation information among the acquired pieces of evaluation information reaches a predetermined number, the weight update unit 11 may execute the processing of the next step S112C and subsequent steps using the predetermined number of pieces of evaluation information.

### (Step S112C)

Subsequently, in step S112C, the weight update unit 11 extracts the first condition c⁽¹⁾ⱼ satisfied by the evaluation information acquired in step S111C from the plurality of first conditions. As an example, the weight update unit 11 extracts a plurality of first conditions c⁽¹⁾ⱼ (for example, c⁽¹⁾₁ “sunny weekday”, c⁽¹⁾₅ “sunny”, c⁽¹⁾₇ “all samples”, and the like) satisfied by the evaluation information. The processing in this step may include processing of extracting, from the set Deval of the evaluation information, a subset D(1)eval_j of the evaluation information satisfying the first condition c⁽¹⁾ⱼ satisfied by the evaluation information acquired in step S111C. Here, an example of the subset D(1)eval_j of the evaluation information is as described with reference to Expression (25).

### (Step S113C)

Subsequently, in step S113C, the weight update unit 11 updates the first weight vector w⁽¹⁾ⱼ relevant to the first condition c⁽¹⁾ⱼ extracted in step S112C.

As an example, the weight update unit 11 updates a plurality of first weight vectors w⁽¹⁾₁, w⁽¹⁾₅, and w⁽¹⁾₇ relevant to a plurality of first conditions c⁽¹⁾₁ “sunny weekday”, c⁽¹⁾₅ “sunny”, and c⁽¹⁾₇ “all samples”. For the update processing of these first weight vectors, as an example, the subsets D(1)eval_1, D(1)eval_5, and D(1)eval_7 of the evaluation information extracted in step S112C are used. However, this does not limit this example.

More specifically, the weight update unit 11 performs processing of:
deriving an evaluation result of each model with reference to the prediction value y\hat{ }ᵢ=fᵢ(x) (i=1, . . . , Nmodel) of each model and the true value (correct value) y; and
updating the element w⁽¹⁾_{j,i} that is an element of the first weight vector w⁽¹⁾ⱼ and is relevant to the model fᵢ, with reference to the derived evaluation result.

Here, a specific update algorithm is not intended to limit the present example embodiment, but as an example, a Hedge algorithm may be used.

$$[ Math . 25 ]$$

$${w}_{j , i}^{( 1 )} ← {w}_{j , i}^{( 1 )} exp ( - {ηℓ}_{i} ) \qquad ( 27 )$$

The element w⁽¹⁾_{j,i} may be updated by this expression. Here,

$$[ Math . 26 ]$$

$${ℓ}_{i} = ℓ ( y , ) \qquad ( 28 )$$

represents a loss function (evaluation result of the model) defined by the prediction value y ᵢ and the true value y, and η represents a learning rate.

In a case where D(1)eval_j includes a plurality of samples, an average value of the loss function in the following expression may be used as an evaluation result of the model.

$$[ Math . 27 ]$$

$${ℓ}_{i}^{mean} = {\sum }_{\{ ( x , y ) in {D}^{( 1 ) eval , j} \}} ℓ ( y , {f}_{i ( x )} ) \qquad ( 29 )$$

In this case, lᵢ in Expression (27) may be replaced with lᵢ^{mean}. Instead of the average value of the loss function, a statistic such as a maximum value or a minimum value of the loss function may be used.

### (Step S114C)

Subsequently, in step S114C, the weight update unit 11 extracts the second condition c⁽²⁾ₖ satisfied by the evaluation information acquired in step S111C from the plurality of second conditions. As an example, the weight update unit 11 extracts one second condition c⁽²⁾ₖ (for example, the second condition c⁽²⁾₁) satisfied by the evaluation information. The processing in this step may include processing of extracting, from the set Deval of the evaluation information, a subset D(2)eval_k of the evaluation information satisfying the second condition c⁽²⁾ⱼ satisfied by the evaluation information acquired in step S111C. Here, an example of the subset D(2)eval_k of the evaluation information is as described with reference to Expression (26).

### (Step S115C)

Subsequently, in step S115C, the weight update unit 11 updates the second weight vector w⁽²⁾ₖ relevant to the second condition c⁽²⁾ₖ extracted in step S114C. As an example, the weight update unit updates one second weight vector w⁽²⁾₁ relevant to one second condition c⁽¹⁾₁ “sunny weekday”. For the update processing of the second weight vector, as an example, the subset D(2)eval_1 of the evaluation information extracted in step S114C is used. However, this does not limit this example.

More specifically, the weight update unit 11 calculates a prediction value for the evaluation information for each of the first conditions c⁽¹⁾ⱼ (j=1, . . . , Nweight(1)) by using the first weight vector w⁽¹⁾ⱼ updated in step S113C. In other words, the weight update unit 11 calculates prediction value y\hat{ }⁽¹⁾ⱼ using the following expression.

$$[ Math . 28 ]$$

$$= {\sum }_{i} {w}_{j , i}^{( 1 )} {f}_{i} ( x ) \qquad ( 30 )$$

Then, the weight update unit 11 performs processing of: deriving an evaluation result of each first weight vector with reference to each prediction value y ⁽¹⁾ⱼ and a true value (correct value) y; and updating each element (in other words, each element relevant to the first weight vector w⁽¹⁾ⱼ) w⁽²⁾_{k,j} that is an element of the second weight vector w⁽²⁾ⱼ and is relevant to each first condition c⁽¹⁾ⱼ, with reference to the derived evaluation result. Here, a specific update algorithm does not limit the present example embodiment, but as an example, a Hedge algorithm may be used as in step S113C.

### (Step S116C)

In step S116C, the weight update unit 11 determines whether there is another piece of evaluation information that has not been processed yet. In a case where there is another piece of evaluation information that has not yet been processed (YES in step S116C), the processing from step S112C is repeated. Otherwise (NO in step S116C), the process ends.

### (Detailed Flow of Prediction Processing)

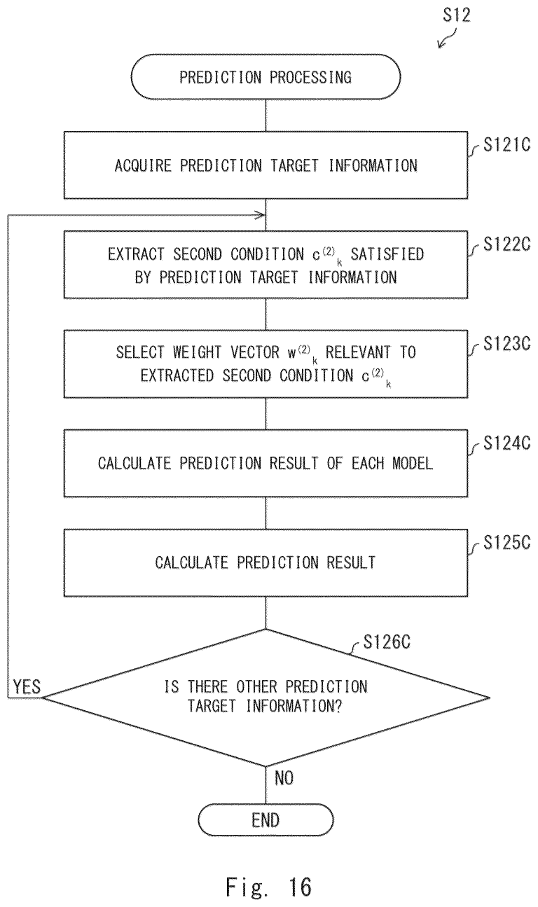

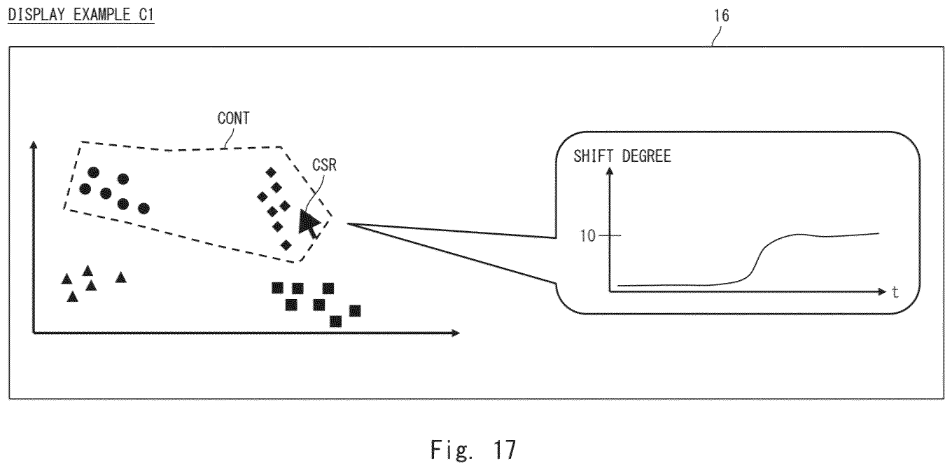

Next, details of the prediction processing S12 will be described with reference to FIG. 16. FIG. 16 is a flowchart illustrating an example of a detailed flow of the prediction processing S12. As illustrated in FIG. 16, the prediction processing S12 includes steps S121C to S126C.

### (Step S121C)

First, in step S121C, the prediction unit 12 acquires a set X of prediction target information. The prediction unit 12 may acquire a set X of prediction target information stored in a memory included in the prediction device 1C, or may acquire a set X of prediction target information received via a network. The set X of prediction target information only needs to include at least one piece of prediction target information, and is not limited to including a plurality of pieces of prediction target information. An example of the set X is as described with reference to Expression (22) and the like.

### (Step S122C)

Subsequently, in step S122C, the prediction unit 12 extracts a second condition c⁽²⁾_k satisfied by the prediction target information from the plurality of second conditions. As an example, the prediction unit 12 extracts one second condition c⁽²⁾_k determined by the prediction target information from the plurality of second conditions.

### (Step S123C)

Subsequently, in step S123C, the prediction unit 12 selects the second weight vector w⁽²⁾_k associated with the second condition c⁽²⁾_k extracted in step S122.

### (Step S124C)

Subsequently, in step S124C, the prediction unit 12 calculates a prediction result fᵢ(x) of each model.

### (Step S125C)

Subsequently, in step S125C, the prediction unit 12 calculates the integrated prediction result y\hat{ } by using the second weight vector w⁽²⁾_k selected in step S123C by

$$[ Math . 29 ]$$

$$\hat{y} = {\sum }_{j} {w}_{k , j}^{( 2 )} {\sum }_{i} {w}_{j , i}^{( 1 )} {f}_{i} ( x ) \qquad ( 31 )$$

This example illustrates an example of a regression task. In Expression (31), it is assumed that each weight vector is normalized, as follows.

$$[ Math . 30 ]$$

$${\sum }_{j} {w}_{k , j}^{( 2 )} = 1$$

$${\sum }_{i} {w}_{j , i}^{( 1 )} = 1$$

In the case of the classification task, as an example, fᵢ(x) represents a vector of a class number dimension, and the prediction probability for each class label i is expressed by fᵢ(x). Then, the prediction unit 12 can calculate the post-integration prediction probability using the same expression as the above Expression (31). In a case where a label is finally determined as a prediction value, the prediction unit 12 determines a class label having the highest probability as the label as the prediction value.

### (Step S126C)

In step S126C, the prediction unit 12 determines whether the set X includes other prediction target information for which the integrated prediction result has not been calculated yet. In a case where other prediction target information is included (YES in step S126C), the processing from step S122C is repeated for the other prediction target information. In a case where the other prediction target information is not included, the integrated prediction result y calculated in step S125C is output, and the process ends. The next weight update processing S11 may be executed using the evaluation information including the model input information included in the prediction target information used in the prediction processing S12 as the model input information for evaluation. However, similarly to the example embodiment defined above, the weight update processing S11 and the prediction processing S12 may be executed independently of each other, and the execution order and the execution timing of each processing are not defined.

### (Example of Display Information Generation Processing S15)

An example of the display information generated by the prediction device 1B executing the display information generation processing S15 will be described with reference to FIG. 17. FIG. 17 is a diagram illustrating a display example C1.

FIG. 17 illustrates an example of display information generated by the display information generation unit 15 and displayed via the input/output unit 16. As illustrated in FIG. 17, the display information includes, as an example, a plurality of data points obtained by embedding the model input information (explanatory variable) in a low-dimensional space (two-dimensional space in the case of FIG. 17).

In the display example C1 illustrated in FIG. 17, data points indicated by the model input information are illustrated using markers having different shapes for each condition satisfied by the model input information. As an example, the data points indicated using the round marker indicate the data points indicated by the model input information (explanatory variable) satisfying the second condition c⁽²⁾₁, and the data points indicated using the diamond marker indicate the data points indicated by the model input information (explanatory variable) satisfying the second condition c⁽²⁾₂.

The prediction unit 12 may specify a set of conditions in which a change occurs in conjunction among a plurality of conditions by referring to the second weight vector, and reflect the set of conditions in the display information. In the example of FIG. 17, the prediction unit 12 finds that the condition satisfied by the model input information indicated by the round data points and the condition satisfied by the model input information indicated by the diamond data points are linked, and the display information generation unit 15 includes the boundary line CONT surrounding these data points in the display information.

As illustrated in FIG. 17, the input/output unit 16 may be configured to display a cursor CSR operable by the user and to select each data point. Also in this configuration, the display information generation unit 15 may be configured to generate display information including additional information to be presented to the user based on an input from the user. The display information generation unit 15 may be configured to generate additional information to be presented to the user based on an input from the user. Examples of the additional information include information obtained from at least one of the first weight and the second weight of each of the plurality of models f_i under the selected conditions c⁽¹⁾ⱼ and c⁽²⁾ₖ and at least one of the first weight and the second weight. As an example, as illustrated in FIG. 17, in a case where the user operates the cursor CSR and selects the first condition c⁽¹⁾₄ and the second condition c⁽²⁾₄, the display information generation unit 15 generates the display information including the shift degree in the first condition c⁽¹⁾₄ and the second condition c⁽²⁾₄. As an example, the display information generation unit 15 calculates the shift degree using the above-described Expression (6) with the weight wᵢ as the following Expression (33).

$$[ Math . 31 ]$$

$${w}_{i} := {{\sum }_{j}}^{{N}^{weight ( 1 )}} {w}_{k , j}^{( 2 )} \times {w}_{j , i}^{( 1 )} \qquad ( 33 )$$

### (Effects of Prediction Device 1C)

According to the prediction device 1C configured as described above, it is possible to accurately update some or all of the plurality of first weight vectors and some or all of the plurality of second weight vectors based on the evaluation result of each model evaluated with reference to the evaluation information and based on the evaluation information referred to for obtaining the evaluation result. At the time of performing prediction, the weight vector selected based on the prediction target information from the plurality of first weight vectors and the plurality of second weight vectors thus updated is used, and thus, it is possible to obtain an effect that the ensemble prediction can be performed with high accuracy even in a case where the distribution of the model input information included in the prediction target information locally changes.

The prediction device 1C generates display information including at least one of the first weight and the second weight of each of the plurality of models f_i in each of the plurality of first conditions c⁽¹⁾ⱼ and the plurality of conditions c⁽²⁾ₖ, and information obtained from at least one of the first weight and the second weight. Therefore, according to the prediction device 1C, it is possible to present to the user what kind of distribution shift has occurred in each of the plurality of first conditions c⁽¹⁾ⱼ and the plurality of conditions c⁽²⁾ₖ over time. According to the prediction device 1C, by using the information of the second weight vector, it is also possible to present information on a condition under which a distribution shift occurs in conjunction with the prediction device 1C.

### [Example of Implementation by Software]

Some or all of the functions of the prediction devices 1, 1A, 1B, and 1C (hereinafter, also referred to as “each of the above-described devices”) may be implemented by hardware such as an integrated circuit (IC chip) or may be implemented by software.

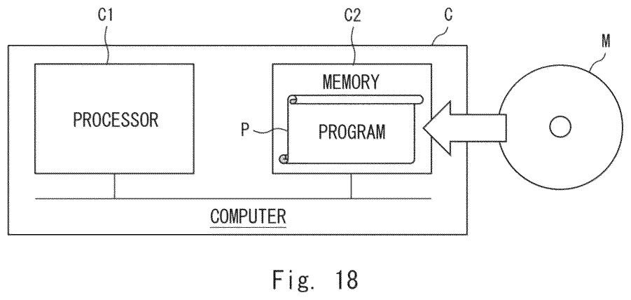

In the latter case, each of the above devices is implemented by, for example, a computer that executes a command of a program which is software for implementing each function. An example of such a computer (hereinafter, referred to as a computer C) is illustrated in FIG. 18. FIG. 18 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to the computer C using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### Supplementary Notes A

The whole or part of the example embodiments disclosed above can be described as the following supplementary notes. However, the present disclosure is not limited to the technologies described in the following supplementary note, and various modifications can be made within the scope described in the claims.

### Supplementary Note A1

A prediction device including
a management means for managing a model pool including a first model and one or more second models that generate one or more post-modulation outputs with reference to an output of the first model, and
a prediction means for executing prediction processing using a plurality of models included in the model pool.

### Supplementary Note A2

The prediction device according to Supplementary Note A1, in which
the prediction means generates a prediction result with reference to an output of each of a plurality of models included in the model pool and a weight of each of the plurality of models, and
the prediction device further includes an update means for updating the weight.

### Supplementary Note A3

The prediction device according to Supplementary Note A2, further including a display information generation means for generating display information including at least one of a weight of each of a plurality of models included in the model pool and information obtained from the weight.

### Supplementary Note A4

The prediction device according to Supplementary Note A2 or A3, in which the display information includes modulation information indicating how to generate the post-modulation output by the second model among a plurality of models included in the model pool.

### Supplementary Note A5

The prediction device according to any one of Supplementary Notes A1 to A4, in which the second model generates the post-modulation output using a polynomial function having an output of the first model as an argument.

### Supplementary Note A6

The prediction device according to any one of Supplementary Notes A1 to A5, in which the first model is a machine learning model.

### Supplementary Note A7

The prediction device according to any one of Supplementary Notes A2 to A4, in which
the update means updates some or all of a plurality of weight vectors based on an evaluation result obtained by evaluating performance of each of a plurality of models included in the model pool with reference to evaluation information including model input information for evaluation obtained over time after operation of the plurality of models is started, and the evaluation information, and
the prediction means outputs a prediction result obtained by integrating prediction results predicted by each of the plurality of models with reference to model input information included in prediction target information related to a prediction target using a weight vector selected based on the prediction target information among the plurality of weight vectors.

### Supplementary Note A8

The prediction device according to any one of Supplementary Notes A2 to A4, in which
the update means updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
the prediction means outputs a prediction result obtained by integrating prediction results predicted by each model with reference to model input information included in prediction target information related to a prediction target using a weight vector selected based on the prediction target information among the plurality of first weight vectors and the plurality of second weight vectors.

### Supplementary Notes B

The whole or part of the example embodiments disclosed above can be described as the following supplementary notes. However, the present disclosure is not limited to the technologies described in the following supplementary note, and various modifications can be made within the scope described in the claims.

### Supplementary Note B1

A prediction method including
management processing in which at least one processor manages a model pool including a first model and one or more second models that generate one or more post-modulation outputs with reference to an output of the first model, and
prediction processing in which the at least one processor executes prediction processing using a plurality of models included in the model pool.

### Supplementary Note B2

The prediction method according to Supplementary Note B1, in which
in the prediction processing, the at least one processor generates a prediction result with reference to an output of each of a plurality of models included in the model pool and a weight of each of the plurality of models, and
the at least one processor further includes update processing for updating the weight.

### Supplementary Note B3

The prediction method according to Supplementary Note B2, in which the at least one processor further includes display information generation processing for generating display information including at least one of a weight of each of a plurality of models included in the model pool and information obtained from the weight.

### Supplementary Note B4

The prediction method according to Supplementary Note B2 or B3, in which the display information includes modulation information indicating how to generate the post-modulation output by the second model among a plurality of models included in the model pool.

### Supplementary Note B5

The prediction method according to any one of Supplementary Notes B1 to B4, in which the second model generates the post-modulation output using a polynomial function having an output of the first model as an argument.

### Supplementary Note B6

The prediction method according to any one of Supplementary Notes B1 to B5, in which the first model is a machine learning model.

### Supplementary Note B7

The prediction method according to any one of Supplementary Notes B2 to B4, in which
in the update processing, the at least one processor updates some or all of a plurality of weight vectors based on an evaluation result obtained by evaluating performance of each of a plurality of models included in the model pool with reference to evaluation information including model input information for evaluation obtained over time after operation of the plurality of models is started, and the evaluation information, and
in the prediction processing, the at least one processor outputs a prediction result obtained by integrating prediction results predicted by each of the plurality of models with reference to model input information included in prediction target information related to a prediction target using a weight vector selected based on the prediction target information among the plurality of weight vectors.

### Supplementary Note B8

The prediction method according to any one of Supplementary Notes B2 to B4, in which
in the update processing, the at least one processor updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
in the prediction processing, the at least one processor outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### Supplementary Notes C

The whole or part of the example embodiments disclosed above can be described as the following supplementary notes. However, the present disclosure is not limited to the technologies described in the following supplementary note, and various modifications can be made within the scope described in the claims.

### Supplementary Note C1

A prediction program for causing a computer to function as a prediction device, the program causing the computer to function as
a management means for managing a model pool including a first model and one or more second models that generate one or more post-modulation outputs with reference to an output of the first model, and
a prediction means for executing prediction processing using a plurality of models included in the model pool.

### Supplementary Note C2

The prediction program according to Supplementary Note C1, in which
the prediction means generates a prediction result with reference to an output of each of a plurality of models included in the model pool and a weight of each of the plurality of models, and
the computer is further caused to function as an update means for updating the weight.

### Supplementary Note C3

The prediction program according to Supplementary Note C2, in which the computer is further caused to function as a display information generation means for generating display information including at least one of a weight of each of a plurality of models included in the model pool and information obtained from the weight.

### Supplementary Note C4

The prediction program according to Supplementary Note C2 or C3, in which the display information includes modulation information indicating how to generate the post-modulation output by the second model among a plurality of models included in the model pool.

### Supplementary Note C5

The prediction program according to any one of Supplementary Notes C1 to C4, in which the second model generates the post-modulation output using a polynomial function having an output of the first model as an argument.

### Supplementary Note C6

The prediction program according to any one of Supplementary Notes C1 to C5, in which the first model is a machine learning model.

### Supplementary Note C7

The prediction program according to any one of Supplementary Notes C2 to C4, in which
the update means updates some or all of a plurality of weight vectors based on an evaluation result obtained by evaluating performance of each of a plurality of models included in the model pool with reference to evaluation information including model input information for evaluation obtained over time after operation of the plurality of models is started, and the evaluation information, and
the prediction means outputs a prediction result obtained by integrating prediction results predicted by each of the plurality of models with reference to model input information included in prediction target information related to a prediction target using a weight vector selected based on the prediction target information among the plurality of weight vectors.

### Supplementary Note C8

The prediction program according to any one of Supplementary Notes C2 to C4, in which
the update means updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and the prediction means outputs a prediction result obtained by integrating prediction results predicted by each model with reference to model input information included in prediction target information related to a prediction target using a weight vector selected based on the prediction target information among the plurality of first weight vectors and the plurality of second weight vectors.

### Supplementary Notes D

The whole or part of the example embodiments disclosed above can be described as the following supplementary notes. However, the present disclosure is not limited to the technologies described in the following supplementary note, and various modifications can be made within the scope described in the claims.

### Supplementary Note D1

A prediction device including at least one processor, in which
the at least one processor executes
management processing in which at least one processor manages a model pool including a first model and one or more second models that generate one or more post-modulation outputs with reference to an output of the first model, and
prediction processing in which prediction processing is executed using a plurality of models included in the model pool.

The prediction device may further include a memory. The memory may store a program for causing the at least one processor to execute the process.

### Supplementary Note D2

The prediction device according to Supplementary Note D1, in which
in the prediction processing, the at least one processor generates a prediction result with reference to an output of each of a plurality of models included in the model pool and a weight of each of the plurality of models, and
the at least one processor further executes update processing for updating the weight.

### Supplementary Note D3

The prediction device according to Supplementary Note D2, in which the at least one processor further executes display information generation processing for generating display information including at least one of a weight of each of a plurality of models included in the model pool and information obtained from the weight.

### Supplementary Note D4

The prediction device according to Supplementary Note D2 or D3, in which the display information includes modulation information indicating how to generate the post-modulation output by the second model among a plurality of models included in the model pool.

### Supplementary Note D5

The prediction device according to any one of Supplementary Notes D1 to D4, in which the second model generates the post-modulation output using a polynomial function having an output of the first model as an argument.

### Supplementary Note D6

The prediction device according to any one of Supplementary Notes D1 to D5, in which the first model is a machine learning model.

### Supplementary Note D7

The prediction device according to any one of Supplementary Notes D2 to D4, in which
in the update processing, the at least one processor updates some or all of a plurality of weight vectors based on an evaluation result obtained by evaluating performance of each of a plurality of models included in the model pool with reference to evaluation information including model input information for evaluation obtained over time after operation of the plurality of models is started, and the evaluation information, and
in the prediction processing, the at least one processor outputs a prediction result obtained by integrating prediction results predicted by each of the plurality of models with reference to model input information included in prediction target information related to a prediction target using a weight vector selected based on the prediction target information among the plurality of weight vectors.

### Supplementary Note D8

The prediction device according to any one of Supplementary Notes D2 to D4, in which
in the update processing, the at least one processor updates some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
in the prediction processing, the at least one processor outputs an integrated prediction result obtained by integrating prediction results predicted by each model with reference to model input information included in prediction target information related to a prediction target using a weight vector selected based on the prediction target information from among the plurality of first weight vectors and the plurality of second weight vectors.

### Supplementary Notes E

The whole or part of the example embodiments disclosed above can be described as the following supplementary note. However, the present disclosure is not limited to the technologies described in the following supplementary note, and various modifications can be made within the scope described in the claims.

### Supplementary Note E1

A non-transitory computer readable medium storing a program that causes a computer to execute:
a management processing of managing a model pool including a first model and one or more second models that generate one or more post-modulation outputs with reference to an output of the first model, and
a prediction processing of executing prediction processing using a plurality of models included in the model pool.

1. A prediction device comprising:
at least one memory storing instructions, and
at least one processor configured to execute the instructions to;
manage a model pool including a first model and one or more second models that generate one or more post-modulation outputs with reference to an output of the first model; and
execute prediction processing using a plurality of models included in the model pool.

2. The prediction device according to claim 1, wherein the at least one processor is further configured to execute the instructions to;
generate a prediction result with reference to an output of each of a plurality of models included in the model pool and a weight of each of the plurality of models, and
update the weight.

3. The prediction device according to claim 2, wherein the at least one processor is further configured to execute the instructions to generate display information including at least one of a weight of each of a plurality of models included in the model pool and information obtained from the weight.

4. The prediction device according to claim 3, wherein the display information includes modulation information indicating how to generate the post-modulation output by the second model among a plurality of models included in the model pool.

5. The prediction device according to claim 1, wherein the second model generates the post-modulation output using a polynomial function having an output of the first model as an argument.

6. The prediction device according to claim 1, wherein the first model is a machine learning model.

7. The prediction device according to claim 2, wherein the at least one processor is further configured to execute the instructions to;
update some or all of a plurality of weight vectors based on an evaluation result obtained by evaluating performance of each of a plurality of models included in the model pool with reference to evaluation information including model input information for evaluation obtained over time after operation of the plurality of models is started, and the evaluation information, and
output a prediction result obtained by integrating prediction results predicted by each of the plurality of models with reference to model input information included in prediction target information related to a prediction target using a weight vector selected based on the prediction target information among the plurality of weight vectors.

8. The prediction device according to claim 2, wherein the at least one processor is further configured to execute the instructions to;
update some or all of a plurality of first weight vectors and some or all of a plurality of second weight vectors based on an evaluation result obtained by evaluating performance of each of a plurality of models with reference to evaluation information including model input information for evaluation and a true value relevant to the model input information, and the evaluation information, and
output a prediction result obtained by integrating prediction results predicted by each model with reference to model input information included in prediction target information related to a prediction target using a weight vector selected based on the prediction target information among the plurality of first weight vectors and the plurality of second weight vectors.

9. A prediction method comprising:
management processing in which at least one processor manages a model pool including a first model and one or more second models that generate one or more post-modulation outputs with reference to an output of the first model; and
prediction processing in which the at least one processor executes prediction processing using a plurality of models included in the model pool.

10. A non-transitory computer readable medium storing a program that causes a computer to execute:
a management processing for managing a model pool including a first model and one or more second models that generate one or more post-modulation outputs with reference to an output of the first model; and
a prediction processing for executing prediction processing using a plurality of models included in the model pool.
